(19) United States
(12) Patent Application Publication
(10) Pub. No.: US 2026/0099807 A1
(43) Pub. Date: Apr. 9, 2026

(54) ELECTRONIC APPARATUS AND PROVIDING INFORMATION METHOD THEREOF

(71) Applicant: Coupang Corp., Seoul (KR)

(72) Inventors: Jun Gyu PARK, Seoul (KR); Taehoon Kang, Seoul (KR); Du Hyeong Kim, Seoul (KR); Ayush Syal, Seoul (KR); Da Young Yoon, Seoul (KR); Yeshwant Nadkarni, Seoul (KR); Rahul Gupta, Seoul (KR); Jagadeesh Virupaksha Huliyar, Seoul (KR); Hong Gyem Kim, Seoul (KR); Rohit Kunal, Seoul (KR); Harshal Wanjari, Seoul (KR); Hwa Jong Park, Seoul (KR); Vikram Balaji, Seoul (KR)

(21) Appl. No.: 19/012,183

(22) Filed: Jan. 7, 2025

(30) Foreign Application Priority Data
Oct. 4, 2024 (KR) 10-2024-0134845

(51) Int. Cl. G06Q 10/087

(52) U.S. Cl. CPC G06Q 10/087

(57) ABSTRACT

Provided is a method of providing information by an electronic apparatus, the method including obtaining a first information request for a first item including information on a first quantity of the first item from a first terminal of a first user, identifying that a first stock keeping unit (SKU) corresponding to the first item is one of a plurality of SKUs arranged in first-type zone groups within a plurality of fulfillment centers, determining a product delivery date (PDD) of the first item based on at least one of information on a time of obtaining the first information request, information on a type of a camp corresponding to a first address set as a delivery location by the first user, stock information of the first-type zone groups, and the information on the first quantity, and providing the first terminal with information on the PDD of the first item.

### CROSS-REFERENCE TO RELATED APPLICATION(S)

This application claims the benefit of Korean Patent Application No. 10-2024-0134845, filed on Oct. 4, 2024, in the Korean Intellectual Property Office, the disclosure of which is incorporated herein by reference.

### BACKGROUND

### 1. Field of the Invention

Example embodiments relate to an electronic apparatus for delivering an item to a customer more efficiently based on a zone group of areas into which a fulfillment center is divided according to a delivery manner or an order deadline for fast delivery of an item and a control method thereof.

### 2. Description of the Related Art

As Internet usage becomes common, the electronic commerce (E-commerce) market enlarges. In particular, due to the spread of infectious disease, interest in E-commerce and online purchasing, which enables product purchase without contact, are rapidly increasing. Items sold through E-commerce may be stocked in a fulfillment center and delivered to a delivery location of a customer through a release process based on the order information of the customer.

In this case, by dividing the fulfillment center into zones or areas and setting a delivery manner or an order deadline for fast delivery of an item differently for each zone group including one or more zones, more efficient delivery of the item to the customer is required.

### SUMMARY

Aspects of example embodiments provide an electronic apparatus and a method of providing information thereof. More specifically, aspects of example embodiments provide an electronic apparatus for delivering an item to a customer more efficiently based on a zone group of areas into which a fulfillment center is divided according to a delivery manner or an order deadline for fast delivery of an item and a control method thereof.

Example embodiments are not limited to the technical features described above, and other technical features may be inferred from the example embodiments below.

According to an aspect, there is provided a method of providing information by an electronic apparatus, the method including obtaining a first information request for a first item including information on a first quantity of the first item from a first terminal of a first user, identifying that a first stock keeping unit (SKU) corresponding to the first item is one of a plurality of SKUs arranged in first-type zone groups within a plurality of fulfillment centers, determining a product delivery date (PDD) of the first item based on at least one of information on a time of obtaining the first information request, information on a type of a camp corresponding to a first address set as a delivery location by the first user, stock information of the first-type zone groups, and the information on the first quantity, and providing the first terminal with information on the PDD of the first item.

Further, in an example embodiment of the present disclosure, the determining of the PDD of the first item may comprise, when the time of obtaining the first information request is before a first order deadline, determining the PDD of the first item as a first time zone.

Further, in an example embodiment of the present disclosure, the determining of the PDD of the first item may comprise, when the time of obtaining the first information request is after a first order deadline and before a second order deadline, identifying the first address set as the delivery location by the first user, when the camp corresponding to the first address is a first-type camp, identifying a first stock quantity of the first SKU arranged in the first-type zone groups based on the stock information of the first-type zone groups, and when the first stock quantity is greater than or equal to the first quantity, determining the PDD of the first item as a first time zone.

Further, in an example embodiment of the present disclosure, the determining of the PDD of the first item may comprise, when the time of obtaining the first information request is after a first order deadline and before a second order deadline, identifying the first address set as the delivery location by the first user, when the camp corresponding to the first address is a first-type camp, identifying a first stock quantity of the first SKU arranged in the first-type zone groups based on the stock information of the first-type zone groups, and when the first stock quantity is less than the first quantity, determining the PDD of the first item as a second time zone.

Further, in an example embodiment of the present disclosure, the determining of the PDD of the first item may comprise, when the time of obtaining the first information request is after a first order deadline and before a second order deadline, identifying the first address set as the delivery location by the first user, when the camp corresponding to the first address is a first-type camp, identifying a first stock quantity of the first SKU arranged in the first-type zone groups based on the stock information of the first-type zone groups, when the first stock quantity is less than the first quantity, identifying a second stock quantity of the first SKU to be arranged in the first-type zone groups within a set time period, and when a sum of the first stock quantity and the second stock quantity is greater than or equal to the first quantity, determining the PDD of the first item as a first time zone.

Further, in an example embodiment of the present disclosure, the determining of the PDD of the first item may comprise, when the time of obtaining the first information request is after a first order deadline and before a second order deadline, identifying the first address set as the delivery location by the first user, and when the camp corresponding to the first address is a second-type camp, determining the PDD of the first item as a second time zone.

Further, in an example embodiment of the present disclosure, the method of providing information may further comprise obtaining information on a first order including information on a first order quantity and a first order time of the first item from the first terminal, and based on the information on the type of the camp corresponding to the first address and the stock information of the first-type zone groups, allocating the first SKU of the first order quantity.

Further, in an example embodiment of the present disclosure, the allocating of the first SKU of the first order quantity may comprise, when the camp corresponding to the first address is a first-type camp, identifying a third stock quantity of the first SKU arranged in the first-type zone groups based on the stock information of the first-type zone groups, and when the third stock quantity is greater than or equal to the first order quantity, allocating the first SKU of the first order quantity to one or more first zone groups having the first SKU in stock among the first-type zone groups.

Further, in an example embodiment of the present disclosure, the allocating of the first SKU of the first order quantity may comprise, when the camp corresponding to the first address is a first-type camp, identifying a third stock quantity of the first SKU arranged in the first-type zone groups based on the stock information of the first-type zone groups, and when the third stock quantity is less than the first order quantity, allocating the first SKU of the third stock quantity to one or more first zone groups having the first SKU in stock among the first-type zone groups and allocating the first SKU of a quantity after subtracting the third stock quantity from the first order quantity to one or more second zone groups having the first SKU in stock among second-type zone groups.

Further, in an example embodiment of the present disclosure, the allocating of the first SKU of the first order quantity may comprise, when the camp corresponding to the first address is a second-type camp, identifying stock information of second-type zone groups, identifying a fourth stock quantity of the first SKU arranged in the second-type zone groups based on the stock information of the second-type zone groups, and when the fourth stock quantity is greater than or equal to the first order quantity, allocating the first SKU of the first order quantity to one or more second zone groups having the first SKU in stock among the second-type zone groups.

Further, in an example embodiment of the present disclosure, the allocating of the first SKU of the first order quantity may comprise, when the camp corresponding to the first address is a second-type camp, identifying stock information of second-type zone groups, identifying a fourth stock quantity of the first SKU arranged in the second-type zone groups based on the stock information of the second-type zone groups, and when the fourth stock quantity is less than the first order quantity, allocating the first SKU of the fourth stock quantity to one or more second zone groups having the first SKU in stock among the second-type zone groups and allocating the first SKU of a quantity after subtracting the fourth stock quantity from the first order quantity to one or more first zone groups having the first SKU in stock among the first-type zone groups.

Further, in an example embodiment of the present disclosure, the first information request may include at least one of a request for a search result page about a list of a plurality of items including the first item, a request for a product detail page about the first item, a request for a cart page about one or more items including the first item, and a request for a payment page about the one or more items.

According to another aspect, there is provided an electronic apparatus including a transceiver, a memory, and a processor, and the processor may be configured to obtain a first information request for a first item including information on a first quantity of the first item from a first terminal of a first user, identify that a first stock keeping unit (SKU) corresponding to the first item is one of a plurality of SKUs arranged in first-type zone groups within a plurality of fulfillment centers, determine a product delivery date (PDD) of the first item based on at least one of information on a time of obtaining the first information request, information on a type of a camp corresponding to a first address set as a delivery location by the first user, stock information of the first-type zone groups, and the information on the first quantity, and provide the first terminal with information on the PDD of the first item.

According to yet another aspect, there is provided a computer-readable recording medium having a program for implementing a method performed by an electronic apparatus.

Additional aspects of example embodiments will be set forth in part in the description which follows and, in part, will be apparent from the description.

According to example embodiments of the present disclosure, by setting packing manner-based cost information or whether to pack in advance an arranged SKU differently for each zone group and changing an item allocation method performed at a fulfillment center level to be performed at a zone group level, it is possible to deliver an item ordered by a user faster and reduce costs for delivery.

In addition, according to example embodiments of the present disclosure, by setting an order deadline at a zone group level rather than at a previous fulfillment center level and setting an order deadline of a first-type zone group, where items frequently purchased by users are arranged, later than an order deadline of other types of zone groups, a user may receive an ordered item faster, thereby enhancing user experiences.

In addition, according to example embodiments of the present disclosure, by identifying whether an SKU of a quantity changed in real-time is arranged in first-type zone groups as an electronic apparatus obtains a user input for changing a quantity and providing information on a product delivery date changed based on a result of identification, it is possible to further induce a user purchase and enhance user experiences.

In addition, according to example embodiments of the present disclosure, by determining a product delivery date of an item as an electronic apparatus considers not only a quantity of stocks currently arranged in a fulfillment center but also a quantity of stocks to be arranged within a set time period, it is possible to further induce a user purchase and enhance user experiences.

The technical benefits achieved by example embodiments are not limited to those described above, and other technical benefits may be clearly understood by those skilled in the art from the appended claims.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 shows a system according to an example embodiment;

FIGS. 2A to 2B illustrate an example of a zone group according to an example embodiment;

FIG. 3 is a diagram for illustrating a process of allocating an item ordered by a user by an electronic apparatus according to an example embodiment;

FIG. 4 is a diagram for illustrating a process of determining an allocation method of one or more stock keeping units (SKUs) and a packing method of one or more SKUs by an electronic apparatus according to an example embodiment;

FIGS. 5A to 5E are diagrams for illustrating a process of determining an allocation method of one or more SKUs and a packing method of one or more SKUs by an electronic apparatus according to an example embodiment;

FIGS. 6A to 6F are diagrams for illustrating a process of determining an allocation method of one or more SKUs and a packing method of one or more SKUs by an electronic apparatus according to an example embodiment;

FIG. 7 is a diagram for illustrating a process of generating instruction information for picking one or more SKUs by an electronic apparatus according to an example embodiment;

FIG. 8 is a diagram for illustrating a process of generating instruction information for arranging one or more SKUs by an electronic apparatus according to an example embodiment;

FIG. 9 is a diagram for illustrating a process of generating instruction information for moving one or more SKUs by an electronic apparatus according to an example embodiment;

FIGS. 10A to 10B illustrate an example of a user interface provided by an electronic apparatus according to an example embodiment;

FIGS. 11A to 11D illustrate an example of a user interface provided by an electronic apparatus according to an example embodiment;

FIG. 12 is a diagram for illustrating a process of providing information on a product delivery date of an item by an electronic apparatus according to an example embodiment;

FIGS. 13A to 13C illustrate an example of a user interface provided by an electronic apparatus according to an example embodiment;

FIGS. 14A to 14D illustrate an example of stock information processed by an electronic apparatus according to an example embodiment;

FIG. 15 is a diagram for illustrating a process of allocating an item ordered by a user by an electronic apparatus according to an example embodiment;

FIGS. 16A to 16G are diagrams for illustrating a process of determining an allocation method of one or more SKUs and a packing method of one or more SKUs by an electronic apparatus according to an example embodiment;

FIG. 17 is a diagram for illustrating a process of determining candidate zone groups corresponding to one or more SKUs by an electronic apparatus according to an example embodiment;

FIG. 18 shows a flowchart of a method of providing information by an electronic apparatus according to an example embodiment; and

FIG. 19 shows a block diagram of an electronic apparatus according to an example embodiment.

### DETAILED DESCRIPTION

Terms used in example embodiments are selected from currently widely used general terms when possible while considering the functions in the present disclosure. However, the terms may vary depending on the intention of a person skilled in the art, precedents, the emergence of new technology, and the like. Further, in certain cases, there are also terms arbitrarily selected by the applicant, and in these cases, the meaning will be described in detail in the corresponding descriptions. Therefore, the terms used in the present disclosure are not to be construed simply as its designation but based on the meaning of the term and the overall context of the present disclosure.

Throughout the specification, when a part is described as “comprising or including” a component, it does not exclude another component but may further include another component unless otherwise stated.

The expression “at least one of a, b, and c” described throughout the specification may include “a alone,” “b alone,” “c alone,” “a and b,” “a and c,” “b and c,” or “all of a, b, and c.”

In the present disclosure, a “terminal” may be implemented as, for example, a computer or a portable terminal capable of accessing a server or another terminal through a network. Here, the computer may include, for example, a notebook, a desktop computer, and/or a laptop computer which are equipped with a web browser. The portable terminal may be a wireless communication apparatus ensuring portability and mobility and include (but is not limited to) any type of handheld wireless communication apparatus, for example, a tablet PC, a smartphone, a communication-based terminal such as international mobile telecommunication (IMT), code division multiple access (CDMA), W-code division multiple access (W-CDMA), long term evolution (LTE), or the like.

Hereinafter, example embodiments of the present disclosure will be described in detail with reference to the accompanying drawings so that those of ordinary skill in the art to which the present disclosure pertains may easily implement example embodiments of the present disclosure. However, the present disclosure may be implemented in multiple different forms and is not limited to the example embodiments described herein.

Hereinafter, example embodiments of the present disclosure will be described in detail with reference to the accompanying drawings.

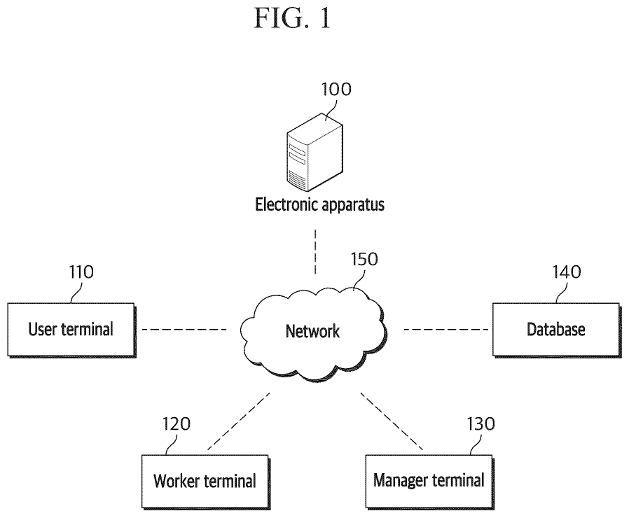

FIG. 1 shows a system according to an example embodiment.

Referring to FIG. 1, the system may include at least one of an electronic apparatus 100, a user terminal 110, a worker terminal 120, a manager terminal 130, a database 140, and a network 150. Meanwhile, in the system illustrated in FIG. 1, only elements related to the example embodiments are illustrated. Therefore, it may be understood by those of ordinary skill in the art to which the example embodiments pertain that other general-purpose elements in addition to the elements illustrated in FIG. 1 may be further included.

The electronic apparatus 100 may be an apparatus that configures and provides a variety of information. The electronic apparatus 100 may provide the configured information to a web page or an application screen or in a form that may be displayed on a web page or an application screen in a terminal provided with information.

According to an example embodiment, the electronic apparatus 100 may determine an allocation method of an item to a zone group to minimize the number of parcels packing an item ordered by a user. For example, the electronic apparatus 100 may obtain information on a first order including information on one or more items from a user terminal, and based on stock information of zone groups within a plurality of fulfillment centers, identify a plurality of zone groups having in stock one or more stock keeping units (SKUs) corresponding to the one or more items among the zone groups. Subsequently, the electronic apparatus 100 may, based on information on a product delivery date (PDD) corresponding to the plurality of zone groups, stock information of the plurality of zone groups, information on a location of a fulfillment center including the plurality of zone groups, and information on costs by packing manner set for the plurality of zone groups, determine candidate zone groups corresponding to each of the one or more SKUs among the plurality of zone groups and determine an allocation method of allocating the one or more SKUs to one or more candidate zone groups among the candidate zone groups to minimize the number of parcels packing the one or more SKUs.

The user terminal 110 may be a terminal used by each user, and users may access a service provided by the network 150 using the individual terminal 110. For example, the electronic apparatus 100 may provide the user terminal 110 with an application for providing information related to orders for various items, and the users may order various items using the application installed in the individual terminal 110. Alternatively, the users may identify real-time delivery information about item orders using the individual terminal 110. In this case, the users may correspond to a customer who is a subject ordering item delivery.

The worker terminal 120 may be a terminal used by each worker, and workers may perform picking work or packing work using the individual terminal 120. For example, the workers may pick one or more SKUs arranged in a designated zone group using the individual terminal 120. Alternatively, the workers may pack a plurality of SKUs with a designated packing material individually or together using the individual terminal 120.

The manager terminal 130 may be a terminal used by a manager, and the manager may manage item allocation work using an application installed in the manager terminal 130. For example, the manager may set a packing manner for each zone group using a user interface displayed on the manager terminal 130. Alternatively, the manager may add a new zone group to a designated zone group or exclude a zone group included in the designated zone group using a user interface displayed on the manager terminal 130.

The database 140 may be a data structure implemented in a predetermined storage space and include a relational database such as MySQL, Oracle, and MSSQL, a non-relational database such as Redis, MongoDB, and CouchDB, an open-source search engine such as Elasticsearch, and a combination thereof. For example, in the database 140, stock information of zone groups within a plurality of fulfillment centers may be stored. Alternatively, in the database 140, information on a packing manner set for each zone group within the plurality of fulfillment centers may be stored. Meanwhile, FIG. 1 illustrates the database 140 present outside the electronic apparatus 100, which is merely an example embodiment though, and the database 140 may be included in the electronic apparatus 100.

The user terminal 110, the worker terminal 120, the manager terminal 130, and the database 140 and the electronic apparatus 100 may communicate with each other within the network 150. The network 150 may include a local area network (LAN), a wide area network (WAN), a value-added network (VAN), a mobile radio communication network, a satellite communication network, and a combination thereof and be a comprehensive data communication network that allows each network constituent illustrated in FIG. 1 to communicate smoothly with each other and include wired Internet, wireless Internet, and a mobile wireless communication network. Wireless communication may include, for example, wireless LAN (Wi-Fi), Bluetooth, Bluetooth low energy, ZigBee, Wi-Fi Direct (WFD), ultra-wideband (UWB), infrared data association (IrDA), and near field communication (NFC) but are not limited thereto.

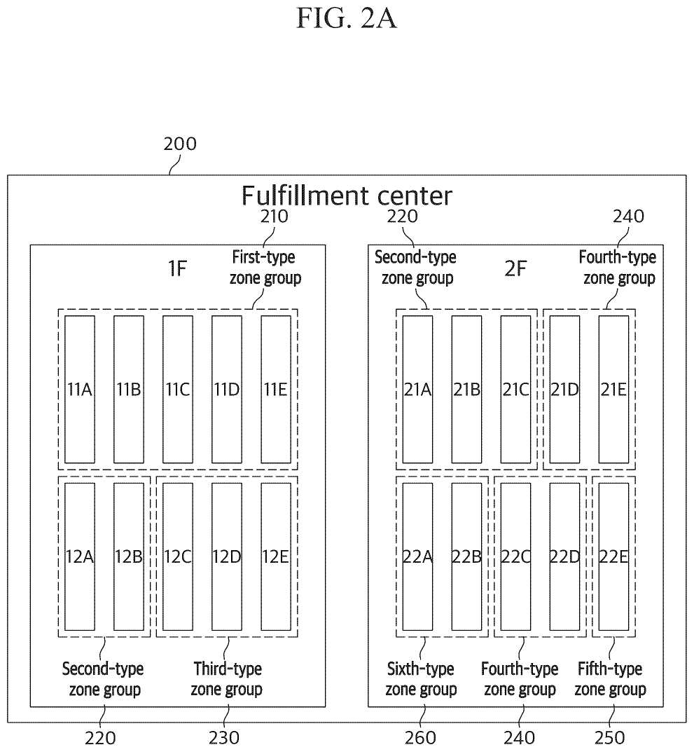

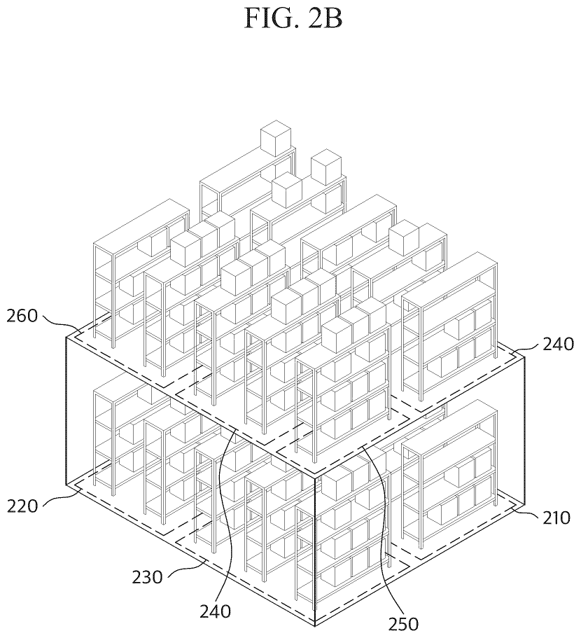

FIGS. 2A to 2B illustrate an example of a zone group according to an example embodiment.

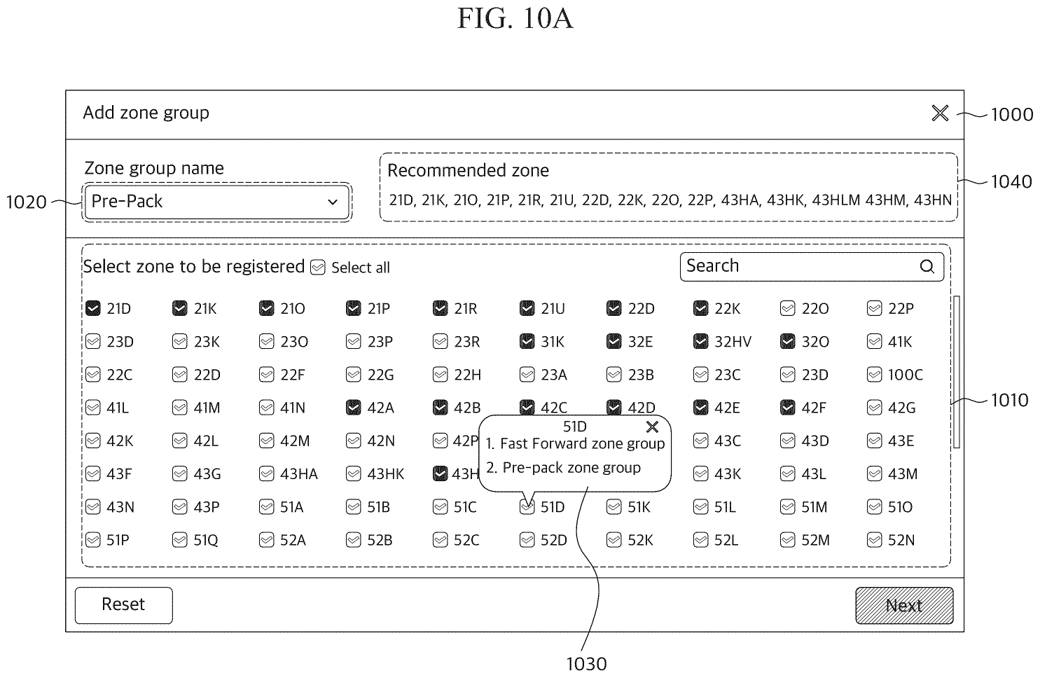

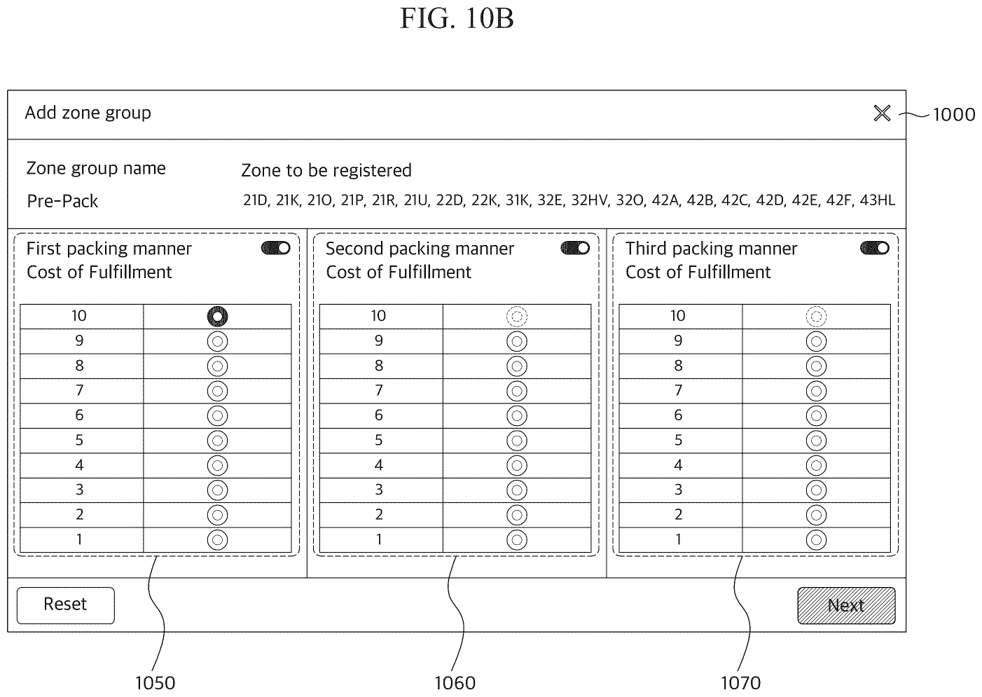

According to an example embodiment, a fulfillment center (FC) may include a plurality of zones. For example, referring to FIGS. 2A and 2B, 10 zones 11A, 11B, 11C, 11D, 11E, 12A, 12B, 12C, 12D, and 12E may be present on a first floor of an FC 200, and 10 zones 21A, 21B, 21C, 21D, 21E, 22A, 22B, 22C, 22D, and 22E may be present on a second floor of the FC 200.

In this case, the zones may be areas into which an FC is divided to manage various types of items loaded in the FC more conveniently, and an SKU corresponding to an item of a designated type for each zone may be arranged. Meanwhile, FIG. 2B illustrates that one display shelf is present in each zone, which is merely an example embodiment though, and a plurality of display shelves may be present in each zone.

According to an example embodiment, one or more zone groups including one or more zones may be present within an FC. For example, referring to FIGS. 2A and 2B, a first-type zone group 210 including 5 zones 11A, 11B, 11C, 11D, and 11E, a second-type zone group 220 including 2 zones 12A and 12B, and a third-type zone group 230 including 3 zones 12C, 12D, and 12E may be present on the first floor of the FC 200. In addition, the second-type zone group 220 including 3 zones 21A, 21B, and 21C, a fourth-type zone group 240 including 2 zones 21D and 21E, a sixth-type zone group 260 including 2 zones 22A and 22B, the fourth-type zone group 240 including 2 zones 22C and 22D, and a fifth-type zone group 250 including 1 zone 22E may be present on the second floor of the FC 200.

In this case, the zone group may be a virtual concept for integrated management of included zones, and cost information by packing manner, a subject performing picking work, or whether to pack in advance an arranged SKU may be set differently based on zone group types.

For example, in a zone included in a first-type zone group, Fast Forward zone group, or central fulfillment center (CFC) zone group, workers may perform arrangement work or picking work directly, and a first-type SKU frequently purchased by users may be arranged. In addition, for the first-type zone group, among a first packing manner of packing SKUs individually, a second packing manner of packing an identical type of SKUs together, and a third packing manner of packing different types of SKUs together, costs by second packing manner may be set cheapest.

For another example, in a zone included in a second-type zone group or Manual zone group, workers may perform arrangement work or picking work directly. In addition, for the second-type zone group, among the first packing manner of packing SKUs individually, the second packing manner of packing an identical type of SKUs together, and the third packing manner of packing different types of SKUs together, costs by second packing manner may be set cheapest.

For another example, in a zone included in a third-type zone group or Pre-pack zone group, workers may perform arrangement work or picking work directly, and SKUs may be individually packed and arranged. In addition, for the third-type zone group, among the first packing manner of packing SKUs individually, the second packing manner of packing an identical type of SKUs together, and the third packing manner of packing different types of SKUs together, costs by first packing manner may be set cheapest.

For another example, in a zone included in a fourth-type zone group or automated guided vehicle (AGV) zone group, an AGV may perform picking work while moving at a determined speed or route. In addition, for the fourth-type zone group, among the first packing manner of packing SKUs individually, the second packing manner of packing an identical type of SKUs together, and the third packing manner of packing different types of SKUs together, costs by third packing manner may be set cheapest.

For another example, in a zone included in a fifth-type zone group or Multi-Manual zone group, workers may perform arrangement work or picking work directly, and a second-type SKU and a third-type SKU frequently purchased together by users may be arranged. In addition, for the fifth-type zone group, among the first packing manner of packing SKUs individually, the second packing manner of packing an identical type of SKUs together, and the third packing manner of packing different types of SKUs together, costs by third packing manner may be set cheapest.

For another example, a zone that is not set as the first-type zone group, the second-type zone group, the third-type zone group, the fourth-type zone group, and the fifth-type zone group may be included in a sixth-type zone group or Unspecified zone group, which is a default value. In zones included in the sixth-type zone group, workers may perform arrangement work or picking work directly. In addition, for the sixth-type zone group, among the first packing manner of packing SKUs individually, the second packing manner of packing an identical type of SKUs together, and the third packing manner of packing different types of SKUs together, costs by second packing manner may be set cheapest.

As described above, by setting packing manner-based cost information or whether to pack in advance an arranged SKU differently for each zone group and changing an item allocation method performed at a fulfillment center level to be performed at a zone group level, an item ordered by a user may be delivered faster and costs for delivery may be reduced.

According to an example embodiment, a deadline by which a user is required to order SKUs arranged in each zone group to be delivered at a specific time zone or an order deadline may be set differently for each zone group. For example, a deadline by which users are required to order SKUs arranged in a first-type zone group to be delivered at dawn on a following day may be set to 11:59 PM, and a deadline by which users are required to order SKUs arranged in a zone group other than the first-type zone group to be delivered at dawn on a following day may be set to 9 PM. However, this is merely an example embodiment, and the order deadline may be set differently from the above description.

As described above, by setting an order deadline at a zone group level, which is previously set at a fulfillment center level, and setting an order deadline of a first-type zone group, where items frequently purchased by users are arranged, later than an order deadline of other types of zone groups, a user may receive an ordered item faster, thus enhancing user experiences.

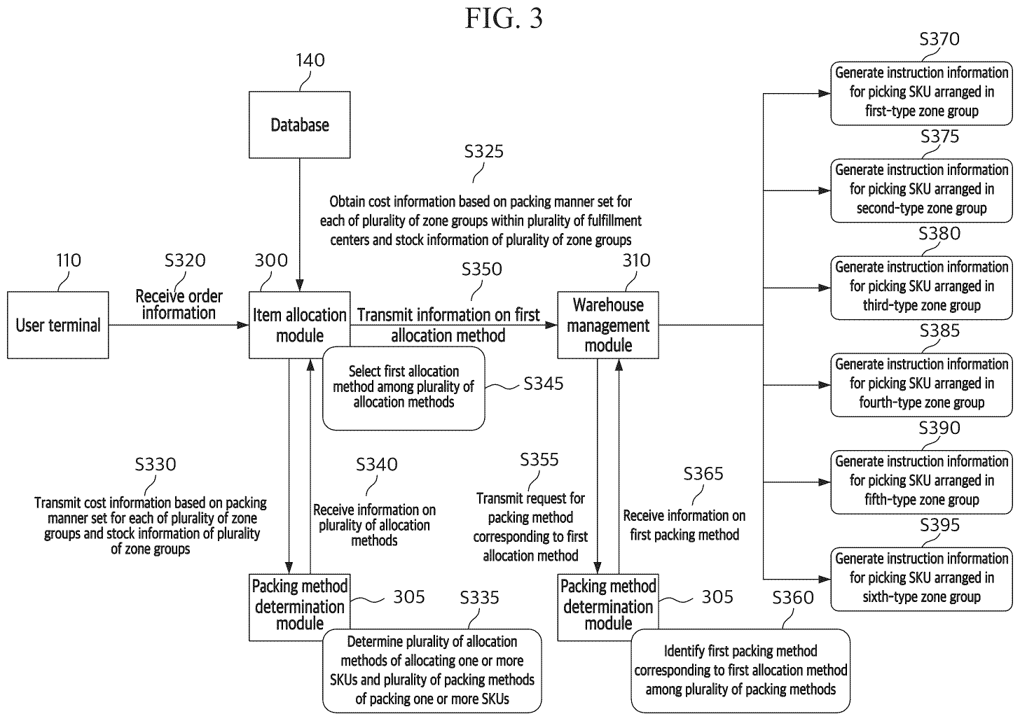

FIG. 3 is a diagram for illustrating a process of allocating an item ordered by a user by the electronic apparatus 100 according to an example embodiment. Each of an item allocation module 300, a packing method determination module 305, and a warehouse management module 310 illustrated in FIG. 3 may be included in the electronic apparatus 100 or included in a server present outside the electronic apparatus 100.

In operation S320, the item allocation module 300 may receive order information from the user terminal 110 according to an example embodiment. For example, the user terminal 110 may transmit order information including information on one or more items ordered by a user and information on a delivery location to the item allocation module 300.

In operation S325, the item allocation module 300 may obtain cost information based on a packing manner set for each of a plurality of zone groups within a plurality of fulfillment centers and stock information of the plurality of zone groups from the database 140 according to an example embodiment. For example, the item allocation module 300 may obtain cost information based on a packing manner set for each of the plurality of zone groups and stock information of the plurality of zone groups from the database 140 as the order information is received from the user terminal 110.

According to an example embodiment, the item allocation module 300 may obtain real-time stock information of the plurality of zone groups from the database 140. For example, the item allocation module 300 may obtain the stock information of the plurality of zone groups repeatedly at each set period from the database 140. The obtained real-time stock information of the plurality of zone groups may be used for overall management and incoming/outgoing processes for a fulfillment center, such as a procedure of allocating an SKU corresponding to an item ordered by a user to a zone group, a procedure of determining a type of a zone group corresponding to each zone, or a procedure of generating instruction information for arranging SKUs in a zone group. As a result, data processing speed may increase, a load to the electronic apparatus 100 may decrease, and scalability and efficiency in operating a fulfillment center may be enhanced. In operation S330, the item allocation module 300 may transmit the cost information based on the packing manner set for each of the plurality of zone groups and the stock information of the plurality of zone groups to the packing method determination module 305 according to an example embodiment. For example, the item allocation module 300, as the cost information based on the packing manner set for each of the plurality of zone groups and the stock information of the plurality of zone groups are obtained, may transmit a request for an item allocation method together with the obtained cost information based on the packing manner set for each of the plurality of zone groups and the obtained stock information of the plurality of zone groups to the packing method determination module 305.

In operation S335, the packing method determination module 305 may determine a plurality of allocation methods of allocating one or more SKUs and a plurality of packing methods of packing the one or more SKUs according to an example embodiment. For example, the packing method determination module 305 may identify a plurality of zone groups having in stock one or more SKUs corresponding to the one or more items based on stock information of zone groups. Subsequently, the packing method determination module 305, based on cost information based on a packing manner set for each of the plurality of zone groups, may determine the allocation methods of the one or more SKUs and the packing methods of the one or more SKUs to minimize picking and packing costs of the one or more SKUs. In addition, the packing method determination module 305 may determine a packing material for packing the one or more SKUs according to the packing methods thereof.

According to an example embodiment, the packing method determination module 305 may determine the plurality of allocation methods of allocating the one or more SKUs and the plurality of packing methods of packing the one or more SKUs based on real-time data. For example, the packing method determination module 305 may determine optimized SKU allocation methods based on real-time user location information, real-time stock information of a plurality of zone groups, and information on real-time capacity of a fulfillment center. In this case, the database 140 may be configured as a data structure optimum for processing and storing real-time data streams.

As above, as the packing method determination module 305 determines optimum SKU allocation methods based on real-time information, a need for manual involvement may be minimized, and by rapidly responding to variations of demands and stock availability, processing time may decrease. In addition, as order processing speed is improved and a calculation process for managing stock distribution is simplified, a load for the electronic apparatus 100 may decrease.

In operation S340, the item allocation module 300 may receive information on the plurality of allocation methods from the packing method determination module 305 according to an example embodiment. For example, the packing method determination module 305 may transmit the information on the plurality of allocation methods of allocating the one or more SKUs to the item allocation module 300.

In operation S345, the item allocation module 300 may select a first allocation method among the plurality of allocation methods according to an example embodiment. For example, the item allocation module 300 may select the first allocation method with the least estimated cost for picking and packing the one or more SKUs based on the plurality of allocation methods and the plurality of packing methods. Alternatively, the item allocation module 300 may identify a priority of a fulfillment center, within which zone groups with SKUs allocated fall, and may select the first allocation method corresponding to a zone group falling within a fulfillment center with the highest priority. Alternatively, the item allocation module 300 may select the first allocation method in which the number of corresponding parcels is the least.

In operation S350, the item allocation module 300 may transmit information on the first allocation method to the warehouse management module 310 according to an example embodiment. For example, the item allocation module 300 may transmit information on the first allocation method with the least estimated cost for picking and packing the one or more SKUs to the warehouse management module 310.

In operation S355, the warehouse management module 310 may transmit a request for a packing method corresponding to the first allocation method to the packing method determination module 305 according to an example embodiment. For example, the warehouse management module 310 may transmit the request for the packing method corresponding to the first allocation method to the packing method determination module 305 as the information on the first allocation method is received from the item allocation module 300.

In operation S360, the packing method determination module 305 may identify a first packing method corresponding to the first allocation method among the plurality of packing methods according to an example embodiment. For example, the packing method determination module 305 may identify the first packing method corresponding to the first allocation method and a packing material for packing the one or more SKUs based on the first packing method as the request for the packing method corresponding to the first allocation method is received from the warehouse management module 310.

In operation S365, the warehouse management module 310 may receive information on the first packing method from the packing method determination module 305 according to an example embodiment. For example, the packing method determination module 305 may transmit the information on the first packing method and information on the packing material for packing the one or more SKUs based on the first packing method to the warehouse management module 310.

In operation S370, the warehouse management module 310 may generate instruction information for picking an SKU arranged in a first-type zone group according to an example embodiment. For example, the warehouse management module 310 may generate instruction information for picking at least one SKU among the one or more SKUs from the first-type zone group based on the first allocation method.

In this case, in a zone included in the first-type zone group, workers may perform arrangement work or picking work directly, and costs by second packing manner of packing an identical type of SKUs together may be set cheapest.

In operation S375, the warehouse management module 310 may generate instruction information for picking an SKU arranged in a second-type zone group according to an example embodiment. For example, the warehouse management module 310 may generate instruction information for picking at least one SKU among the one or more SKUs from the second-type zone group based on the first allocation method.

In this case, in a zone included in the second-type zone group, an AGV may perform picking work while moving at a determined speed or route, and costs by third packing manner of packing different types of SKUs together may be set cheapest.

In operation S380, the warehouse management module 310 may generate instruction information for picking an SKU arranged in a third-type zone group according to an example embodiment. For example, the warehouse management module 310 may generate instruction information for picking at least one SKU among the one or more SKUs from the third-type zone group based on the first allocation method.

In this case, in a zone included in the third-type zone group, workers may perform arrangement work or picking work directly, and SKUs may be individually packed and arranged. In addition, costs by first packing manner of packing SKUs individually may be set cheapest.

In operation S385, the warehouse management module 310 may generate instruction information for picking an SKU arranged in a fourth-type zone group according to an example embodiment. For example, the warehouse management module 310 may generate instruction information for picking at least one SKU among the one or more SKUs from the fourth-type zone group based on the first allocation method.

In this case, in a zone included in the fourth-type zone group, workers may perform arrangement work or picking work directly, and a first-type SKU frequently purchased by users may be arranged. In addition, costs by second packing manner of packing an identical type of SKUs together may be set cheapest, and an order deadline of items corresponding to an SKU arranged in a zone included in the fourth-type zone group may be set later than an order deadline of items corresponding to an SKU arranged in a zone included in other types of zone groups.

In operation S390, the warehouse management module 310 may generate instruction information for picking an SKU arranged in a fifth-type zone group according to an example embodiment. For example, the warehouse management module 310 may generate instruction information for picking at least one SKU among the one or more SKUs from the fifth-type zone group based on the first allocation method.

In this case, in a zone included in the fifth-type zone group, workers may perform arrangement work or picking work directly, and a second-type SKU and a third-type SKU frequently purchased together by users may be arranged. In addition, costs by third packing manner of packing different types of SKUs together may be set cheapest, and SKUs arranged in a zone included in the fifth-type zone group may be packed after picking work and rebin work of gathering the picked SKUs in a designated area.

In operation S395, the warehouse management module 310 may generate instruction information for picking an SKU arranged in a sixth-type zone group according to an example embodiment. For example, the warehouse management module 310 may generate instruction information for picking at least one SKU among the one or more SKUs from the sixth-type zone group based on the first allocation method.

In this case, a zone for which a corresponding zone group is not set may be included in the sixth-type zone group, which is a default value. In a zone included in the sixth-type zone group, workers may perform arrangement work or picking work directly, and costs by second packing manner of packing an identical type of SKUs together may be set cheapest.

According to an example embodiment, the item allocation module 300, the packing method determination module 305, and the warehouse management module 310 illustrated in FIG. 3 may be included in a server located near the user terminal 110. For example, the item allocation module 300, the packing method determination module 305, and the warehouse management module 310 may perform operation S320 to operation S395 within a server located near the user terminal 110 rather than a central server based on edge-computing technology or distributed processing technology.

Accordingly, SKUs may be allocated in real-time without a delay required to transmit data to the central server, through which order processing efficiency may increase by rapidly responding to a change in user location and stock levels. In addition, by processing data in a location closer to a source, a risk of bottleneck may decrease and overall responsiveness in a platform may be improved. As a result, network latency and traffic may be reduced, and general performance in the platform may be enhanced along with the speed and reliability of SKU allocation processes.

Meanwhile, FIG. 3 illustrates that operation S370 to operation S395 are performed sequentially, which is merely an example embodiment though, and based on a selected first allocation method, only some of operation S370 to operation S395 may be performed and some of operation S370 to operation S395 may be performed simultaneously.

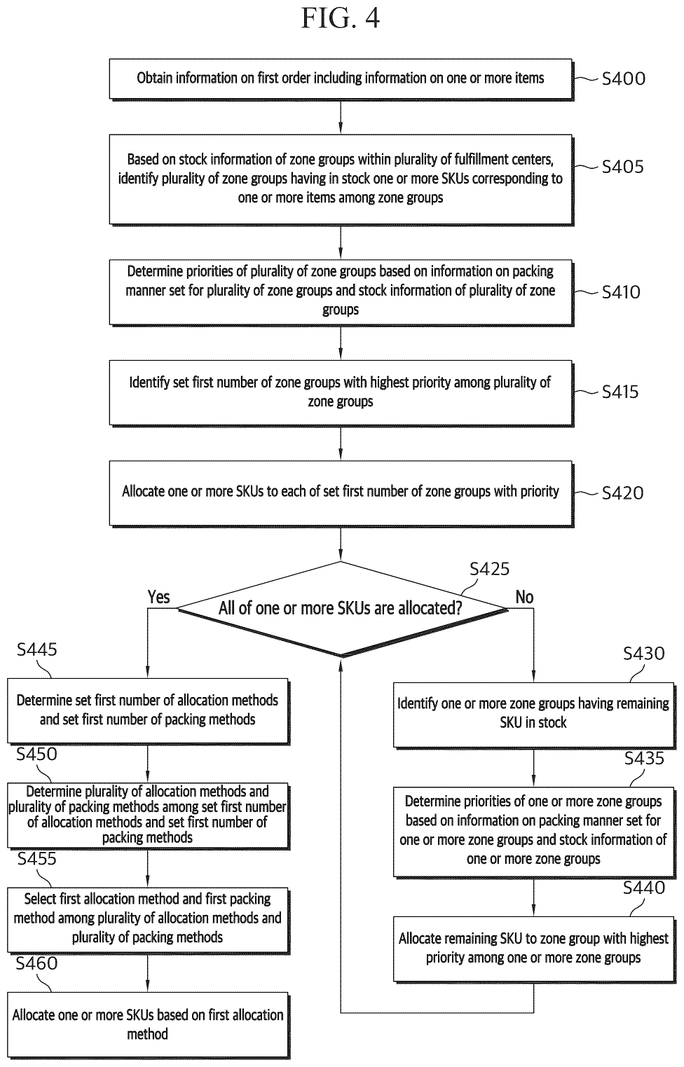

FIG. 4 is a diagram for illustrating a process of determining an allocation method of one or more SKUs and a packing method of one or more SKUs by the electronic apparatus 100 according to an example embodiment.

In operation S400, the electronic apparatus 100 may obtain information on a first order including information on one or more items according to an example embodiment. For example, the user terminal 110 may transmit order information including information on one or more items ordered by a user and information on a delivery location to the electronic apparatus 100.

In operation S405, according to an example embodiment, the electronic apparatus 100 may, based on stock information of zone groups within a plurality of fulfillment centers, identify a plurality of zone groups having in stock one or more SKUs corresponding to the one or more items among the zone groups. For example, as the information on the first order is obtained, the electronic apparatus 100 may identify stock information of zone groups within a plurality of fulfillment centers, which is stored in the database 140. Subsequently, the electronic apparatus 100 may identify a plurality of zone groups having in stock one or more SKUs corresponding to the one or more items based on the stock information of the zone groups within the plurality of fulfillment centers.

In operation S410, according to an example embodiment, the electronic apparatus 100 may determine priorities of the plurality of zone groups based on information on a packing manner set for the plurality of zone groups and the stock information of the plurality of zone groups. More specifically, the electronic apparatus 100 may determine the priorities of the plurality of zone groups based on at least one of a first criterion about a packing manner and the number of SKU types, a second criterion about the number of SKU types, a third criterion about the number of SKU stocks, and a fourth criterion about a fulfillment center within which a zone group falls.

For example, based on the first criterion, the electronic apparatus 100 may assign the highest priority to a zone group, in which a packing manner is set as the third packing manner of packing different types of SKUs together and the number of types of SKUs in stock among the one or more SKUs is 2 or more, among the plurality of zone groups.

When zone groups to which an identical priority is assigned based on the first criterion are present, the electronic apparatus 100 may, based on the second criterion, assign a higher priority as the number of types of SKUs in stock among the one or more SKUs is more.

When zone groups to which an identical priority is assigned based on the second criterion are present, the electronic apparatus 100 may, based on the third criterion, assign a higher priority as a stock quantity of the one or more SKUs is more.

When zone groups to which an identical priority is assigned based on the third criterion are present, the electronic apparatus 100 may, based on the fourth criterion, identify a first zone group having the highest priority and assign a higher priority to a zone group falling within an identical fulfillment center to the first zone group.

When zone groups to which an identical priority is assigned based on the fourth criterion are present, the electronic apparatus 100 may assign a priority arbitrarily or assign a higher priority to a zone group that falls within a fulfillment center with a higher priority. In this case, a priority of a fulfillment center may be determined to be higher as being located closer to a delivery location of an order, as being located closer to a fulfillment center within which a zone group with the highest priority falls, or as average release time is shorter.

In operation S415, the electronic apparatus 100 may identify a set first number of zone groups with the highest priority among the plurality of zone groups according to an example embodiment. For example, the electronic apparatus 100 may identify 3 zone groups with the highest priority among the plurality of zone groups, a first fulfillment center—a first zone group, the first fulfillment center—a second zone group, and a second fulfillment center—the second zone group. However, the first number may be set as a different value from the above example or changed depending on an input of a manager.

In operation S420, the electronic apparatus 100 may allocate the one or more SKUs to each of the set first number of zone groups with priority according to an example embodiment. For example, the electronic apparatus 100 may allocate the one or more SKUs to each of the 3 zone groups with the highest priority, the first fulfillment center—the first zone group, the first fulfillment center—the second zone group, and the second fulfillment center—the second zone group.

In operation S425, the electronic apparatus 100 may identify whether all of the one or more SKUs are allocated according to an example embodiment. For example, the electronic apparatus 100 may identify whether all of the one or more SKUs are allocated as each of the first fulfillment center—the first zone group, the first fulfillment center—the second zone group, and the second fulfillment center—the second zone group has all of the one or more SKUs in stock. When a zone group to which all of the one or more SKUs are not allocated is present, the electronic apparatus 100 may perform operation S430 for the corresponding zone group, and when all of the one or more SKUs are allocated, the electronic apparatus 100 may perform operation S445.

In operation S430, the electronic apparatus 100 may identify one or more zone groups having a remaining SKU in stock according to an example embodiment. For example, when it is identified that all of the one or more SKUs are not allocated to the first fulfillment center—the first zone group among the first fulfillment center—the first zone group, the first fulfillment center—the second zone group, and the second fulfillment center—the second zone group, the electronic apparatus 100 may identify one or more zone groups having an unallocated SKU in stock among the plurality of zone groups.

In operation S435, according to an example embodiment, the electronic apparatus 100 may determine priorities of the one or more zone groups based on information on a packing manner set for the one or more zone groups and stock information of the one or more zone groups. More specifically, the electronic apparatus 100 may determine the priorities of the one or more zone groups based on a first criterion about a packing manner and the number of SKU types, a second criterion about the number of SKU types, a third criterion about the number of SKU stocks, and a fourth criterion about a fulfillment center within which a zone group falls.

For example, based on the first criterion, the electronic apparatus 100 may assign the highest priority to a zone group, in which a packing manner is set as the third packing manner of packing different types of SKUs together and the number of types of SKUs in stock among the one or more SKUs is 2 or more, among the one or more zone groups.

When zone groups to which an identical priority is assigned based on the first criterion are present, the electronic apparatus 100 may, based on the second criterion, assign a higher priority as the number of types of SKUs in stock among the one or more SKUs is more.

When zone groups to which an identical priority is assigned based on the second criterion are present, the electronic apparatus 100 may, based on the third criterion, assign a higher priority as a stock quantity of the one or more SKUs is more.

When zone groups to which an identical priority is assigned based on the third criterion are present, the electronic apparatus 100 may, based on the fourth criterion, identify a first zone group having the highest priority and assign a higher priority to a zone group falling within an identical fulfillment center to the first zone group.

When zone groups to which an identical priority is assigned based on the fourth criterion are present, the electronic apparatus 100 may assign a priority arbitrarily or assign a higher priority to a zone group that falls within a fulfillment center with a higher priority. In this case, a priority of a fulfillment center may be determined to be higher as being located closer to a delivery location of an order, as being located closer to a fulfillment center within which a zone group with the highest priority falls, or as average release time is shorter.

In operation S440, the electronic apparatus 100 may allocate the remaining SKU to a zone group with the highest priority among the one or more zone groups according to an example embodiment. For example, the electronic apparatus 100 may allocate the unallocated SKU to the first fulfillment center—a third zone group with the highest priority among the one or more zone groups.

As above, the electronic apparatus 100 may perform operation S425 to operation S440 repeatedly until all of the one or more SKUs are allocated.

In operation S445, the electronic apparatus 100 may determine a set first number of allocation methods and a set first number of packing methods. For example, the electronic apparatus 100 may determine a first allocation method of allocating the one or more SKUs to the first fulfillment center—the first zone group and the first fulfillment center—the third zone group and accordingly a first packing method of packing the one or more SKUs. In addition, the electronic apparatus 100 may determine a second allocation method of allocating the one or more SKUs to the first fulfillment center—the second zone group and accordingly a second packing method of packing the one or more SKUs. The electronic apparatus 100 may determine a third allocation method of allocating the one or more SKUs to the second fulfillment center—the second zone group and accordingly a third packing method of packing the one or more SKUs.

According to an example embodiment, the electronic apparatus 100 may change some packing methods among the set first number of packing methods based on a consolidated packing threshold value set for a fulfillment center. In this case, the consolidated packing threshold value may refer to a maximum value of parcels that may be provided to one user in a specific fulfillment center and may be set to different values for each fulfillment center by a manager.

For example, the electronic apparatus 100 may identify that the number of parcels provided from the first fulfillment center is 5 when the one or more SKUs are packed based on the first packing method and a consolidated packing threshold value of the first fulfillment center is 4. Accordingly, the electronic apparatus 100 may change the first packing method so that a different type of SKU allocated to the first fulfillment center—the third zone group is packed together even though a packing manner of the first fulfillment center—the third zone group is set as the second packing manner of packing an identical type of SKUs together. As a result, the number of parcels when the one or more SKUs are packed based on the first packing method may be changed to 3, a value smaller than the consolidated packing threshold value.

As described above, as the electronic apparatus 100 changes a packing method based on a consolidated packing threshold value set for each fulfillment center, a decline in user experiences due to excessively many parcels received by users may be improved.

In operation S450, the electronic apparatus 100 may determine a plurality of allocation methods and a plurality of packing methods among the set first number of allocation methods and the set first number of packing methods according to an example embodiment. For example, the electronic apparatus 100 may determine the set first number of allocation methods and the set first number of packing methods as the plurality of allocation methods and the plurality of packing methods. Alternatively, the electronic apparatus 100 may determine a set second number of allocation methods and a set second number of packing methods of which the number of corresponding parcels is the least among the set first number of allocation methods and the set first number of packing methods as the plurality of allocation methods and the plurality of packing methods.

However, the process of performing operation S450 by the electronic apparatus 100 may be omitted according to an example embodiment.

In operation S455, the electronic apparatus 100 may select a first allocation method and a first packing method among the plurality of allocation methods and the plurality of packing methods according to an example embodiment. More specifically, the electronic apparatus 100 may select the first allocation method and the first packing method among the plurality of allocation methods and the plurality of packing methods based on an input of a manager, information on the number of parcels, information on a priority of a fulfillment center, or information on estimated cost.

For example, the manager terminal 130 may obtain input from a manager for selecting the first allocation method among the plurality of allocation methods and transmit information on the selected first allocation method to the electronic apparatus 100. Accordingly, the electronic apparatus 100 may select the first packing method corresponding to the first allocation method.

For another example, the electronic apparatus 100 may select the first allocation method of which the number of corresponding parcels is the least and the first packing method according thereto among the plurality of allocation methods and the plurality of packing methods.

For another example, the electronic apparatus 100 may identify that the number of parcels corresponding to the first allocation method and a second allocation method among the plurality of allocation methods is 4, which is the least. Accordingly, the electronic apparatus 100 may identify information on priorities of fulfillment centers within which zone groups corresponding to the first allocation method and the second allocation method fall. Subsequently, the electronic apparatus 100 may identify that a priority of a fulfillment center within which a zone group corresponding to the first packing method falls is higher and select the first allocation method and the first packing method according thereto. In this case, a priority of a fulfillment center may be determined to be higher as being located closer to a delivery location of an order, as being located closer to a fulfillment center within which a zone group with the highest priority falls, or as average release time is shorter.

For another example, the electronic apparatus 100 may determine estimated costs for allocating and packing the one or more SKUs based on the plurality of allocation methods and the plurality of packing methods and select the first allocation method whose corresponding estimated cost is the least. In this case, the estimated cost may be set less as the number of workers inputted to pick and pack items is less or the time for picking and packing items is less.

In operation S460, the electronic apparatus 100 may allocate the one or more SKUs based on the first allocation method according to an example embodiment. For example, the electronic apparatus 100 may allocate the one or more SKUs to a zone group corresponding to the first allocation method and provide information on the first packing method corresponding to the first allocation method and information on a packing material for packing the one or more SKUs based on the first packing method.

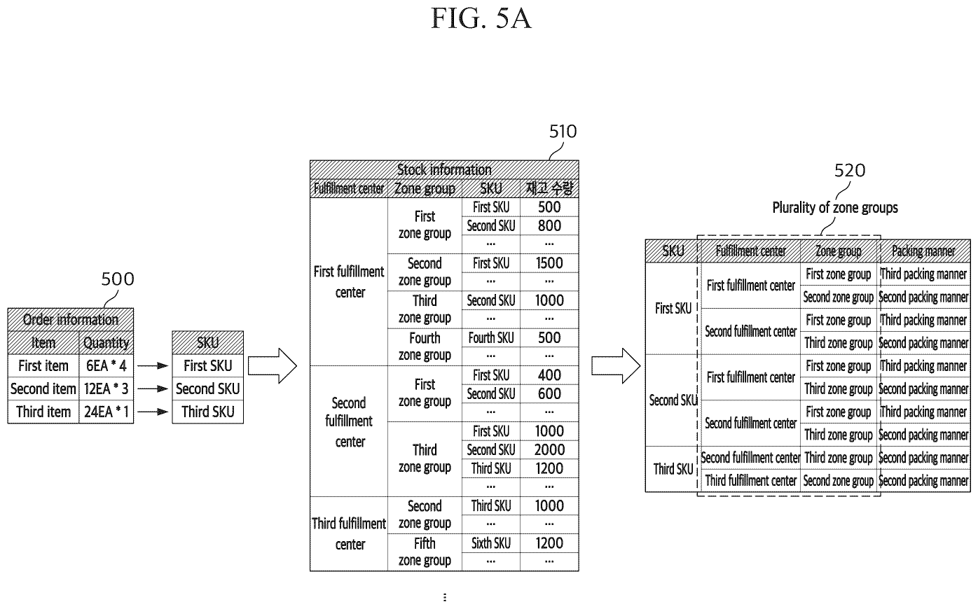

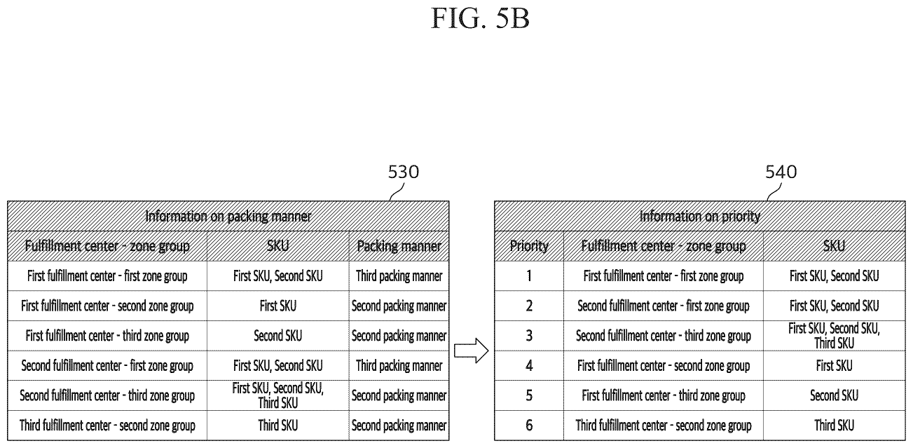

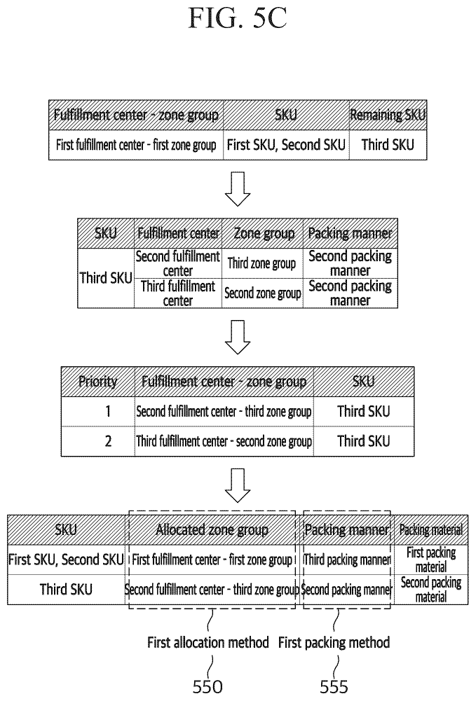

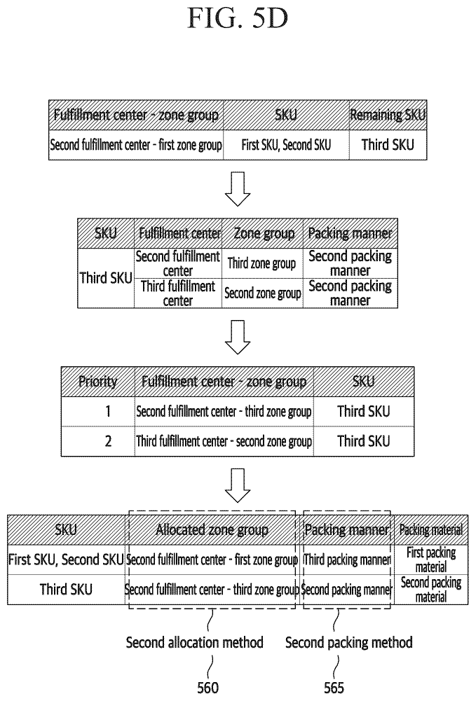

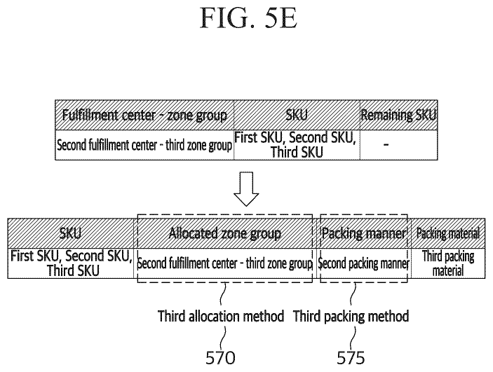

FIGS. 5A to 5E are diagrams for illustrating a process of determining an allocation method of one or more SKUs and a packing method of one or more SKUs by the electronic apparatus 100 according to an example embodiment.

According to an example embodiment, the electronic apparatus 100 may obtain information on a first order including information on one or more items. For example, referring to FIG. 5A, the electronic apparatus 100 may receive order information 500 including information on ordering 4 bundles of 6 of a first item, ordering 3 bundles of 12 of a second item, and ordering 1 bundle of 24 of a third item from the user terminal 110.

According to an example embodiment, the electronic apparatus 100 may identify one or more SKUs corresponding to one or more items included in order information. For example, referring to FIG. 5A, the electronic apparatus 100 may identify a first SKU in which 6 of the first items are grouped and managed, a second SKU in which 12 of the second items are grouped and managed, and a third SKU in which 24 of the third items are grouped and managed.

According to an example embodiment, based on stock information of zone groups within a plurality of fulfillment centers, the electronic apparatus 100 may identify a plurality of zone groups having in stock the one or more SKUs among the zone groups. For example, referring to FIG. 5A, the electronic apparatus 100 may identify a plurality of zone groups 520 with the first SKU, the second SKU, and the third SKU based on stock information 510 of zone groups within a plurality of fulfillment centers.

According to an example embodiment, the electronic apparatus 100 may determine priorities of the plurality of zone groups based on information on a packing manner set for the plurality of zone groups and stock information of the plurality of zone groups.

For example, referring to FIGS. 5A and 5B, the electronic apparatus 100, based on information 530 on a packing manner set for the plurality of zone groups and the stock information 510 of the plurality of zone groups, may identify that a packing manner of a first fulfillment center—a first zone group and a second fulfillment center—the first zone group is set as the third packing manner and the number of types of SKUs in stock is 2 or more. Accordingly, the electronic apparatus 100 may assign the highest priority to the first fulfillment center—the first zone group and the second fulfillment center—the first zone group. Since the first fulfillment center—the first zone group and the second fulfillment center—the first zone group have identical priorities based on the first criterion, the electronic apparatus 100 may determine priorities of the first SKU and the second SKU based on the second criterion. However, since the number of types of SKUs in stock in the first fulfillment center—the first zone group and the second fulfillment center—the first zone group is 2, identical, so priorities are also identical based on the second criterion, the electronic apparatus 100 may determine the priority of the first fulfillment center—the first zone group (stock quantity of the first SKU: 500, stock quantity of the second SKU: 800) having more stocks of the one or more SKUs as 1 and determine the priority of the second fulfillment center—the first zone group (stock quantity of the first SKU: 400, stock quantity of the second SKU: 600) as 2 based on the third criterion. In addition, since the first fulfillment center—a second zone group, the first fulfillment center—a third zone group, the second fulfillment center—the third zone group, and a third fulfillment center—the second zone group have identical priorities based on the first criterion, the electronic apparatus 100 may determine the priority of the second fulfillment center—the third zone group of which the number of types of SKUs in stock is 3, the most, as 3 based on the second criterion.

In addition, since the number of types of SKUs in stock in the first fulfillment center—the second zone group, the first fulfillment center—the third zone group, and the third fulfillment center—the second zone group is 1, identical, and priorities are identical based on the second criterion, the electronic apparatus 100 may determine the priority of the first fulfillment center—the second zone group (stock quantity of the first SKU: 1500) having the most stocks of the one or more SKUs as 4 based on the third criterion.

In addition, since the first fulfillment center—the third zone group (stock quantity of the second SKU: 1000) and the third fulfillment center—the second zone group (stock quantity of the third SKU: 1000) have identical stocks of the one or more SKUs and have identical priorities based on the third criterion, the electronic apparatus 100 may determine the priority of the first fulfillment center—the third zone group falling within an identical fulfillment center with the first fulfillment center—the first zone group of the highest priority as 5 based on the fourth criterion and determine the priority of the third fulfillment center—the second zone group as 6.

According to an example embodiment, the electronic apparatus 100 may identify a set first number of zone groups with the highest priority among the plurality of zone groups. For example, referring to FIG. 5B, the electronic apparatus 100 may identify 3 zone groups with the highest priority among the plurality of zone groups, the first fulfillment center—the first zone group, the second fulfillment center—the first zone group, and the second fulfillment center—the third zone group, based on information 540 on priority.

According to an example embodiment, the electronic apparatus 100 may allocate the one or more SKUs to each of the set first number of zone groups with priority and determine a set first number of allocation methods and a set first number of packing methods.

For example, referring to FIG. 5C, the electronic apparatus 100 may allocate the one or more SKUs to the first fulfillment center—the first zone group with the highest priority. As it is identified that the first fulfillment center—the first zone group has no stock of the third SKU, the electronic apparatus 100 may identify the second fulfillment center—the third zone group and the third fulfillment center—the second zone group having the third SKU in stock. The electronic apparatus 100 may, based on the information 530 on the packing manner set for each of the second fulfillment center—the third zone group and the third fulfillment center—the second zone group and the stock information 510, determine the priority of the second fulfillment center—the third zone group having more stock quantity of the third SKU as 1 based on the third criterion. Subsequently, the electronic apparatus 100 may identify that all of the one or more SKUs are allocated as the third SKU is allocated to the second fulfillment center—the third zone group. Accordingly, the electronic apparatus 100 may determine a first allocation method 550 and a first packing method 555 so that the first SKU and the second SKU are allocated to the first fulfillment center—the first zone group and packed by the third packing manner and the third SKU is allocated to the second fulfillment center—the third zone group and packed by the second packing manner.

For another example, referring to FIG. 5D, the electronic apparatus 100 may allocate the one or more SKUs to the second fulfillment center—the first zone group with the second highest priority. As it is identified that the second fulfillment center—the first zone group has no stock of the third SKU, the electronic apparatus 100 may identify the second fulfillment center—the third zone group and the third fulfillment center—the second zone group having the third SKU in stock. The electronic apparatus 100 may, based on the information 530 on the packing manner set for each of the second fulfillment center—the third zone group and the third fulfillment center—the second zone group and the stock information 510, determine the priority of the second fulfillment center—the third zone group having more stock quantity of the third SKU as 1 based on the third criterion. Subsequently, the electronic apparatus 100 may identify that all of the one or more SKUs are allocated as the third SKU is allocated to the second fulfillment center—the third zone group. Accordingly, the electronic apparatus 100 may determine a second allocation method 560 and a second packing method 565 so that the first SKU and the second SKU are allocated to the second fulfillment center—the first zone group and packed by the third packing manner and the third SKU is allocated to the second fulfillment center—the third zone group and packed by the second packing manner.

For another example, referring to FIG. 5E, the electronic apparatus 100 may allocate the one or more SKUs to the second fulfillment center—the third zone group with the third highest priority. As it is identified that the second fulfillment center—the third zone group has all of the first SKU, the second SKU, and the third SKU in stock, the electronic apparatus 100 may determine a third allocation method 570 and a third packing method 575 so that the first SKU, the second SKU, and the third SKU are allocated to the second fulfillment center—the third zone group and packed by the second packing manner.

According to an example embodiment, the electronic apparatus 100 may determine a plurality of allocation methods and a plurality of packing methods among the set first number of allocation methods and the set first number of packing methods. More specifically, the electronic apparatus 100 may determine the set first number of allocation methods and the set first number of packing methods as the plurality of allocation methods and the plurality of packing methods or determine a set second number of allocation methods and a set second number of packing methods of which the number of corresponding parcels is the least among the set first number of allocation methods and the set first number of packing methods as the plurality of allocation methods and the plurality of packing methods.

For example, the electronic apparatus 100 may identify that the number of parcels corresponding to the first allocation method 550 and the first packing method 555 is 2, the number of parcels corresponding to the second allocation method 560 and the second packing method 565 is 2, and the number of parcels corresponding to the third allocation method 570 and the third packing method 575 is 8. Subsequently, the electronic apparatus 100 may select two, of which the number of corresponding parcels is the least, the first allocation method 550 and the first packing method 555 and the second allocation method 560 and the second packing method 565.

According to an example embodiment, the electronic apparatus 100 may select one allocation method and a corresponding packing method among the plurality of allocation methods and the plurality of packing methods. More specifically, the electronic apparatus 100 may select one allocation method and the corresponding packing method among the plurality of allocation methods and the plurality of packing methods based on an input of a manager, information on the number of parcels, information on a priority of a fulfillment center, or information on estimated cost.

For example, as it is identified that the numbers of parcels corresponding to the first allocation method 550 and the second allocation method 560 are 2, identical, the electronic apparatus 100 may select the first allocation method 550 corresponding to the first fulfillment center—the first zone group, close to a delivery location, and the first packing method 555 corresponding thereto.

For another example, as it is identified that the numbers of parcels corresponding to the first allocation method 550 and the second allocation method 560 are 2, identical, the electronic apparatus 100 may select the first allocation method 550 of which a corresponding estimated cost is least and the first packing method 555 corresponding thereto.

According to an example embodiment, the electronic apparatus 100 may allocate the one or more SKUs based on a selected allocation method. For example, the electronic apparatus 100 may allocate the first SKU and the second SKU to the first fulfillment center—the first zone group and the third SKU to the second fulfillment center—the third zone group based on the first allocation method 550.

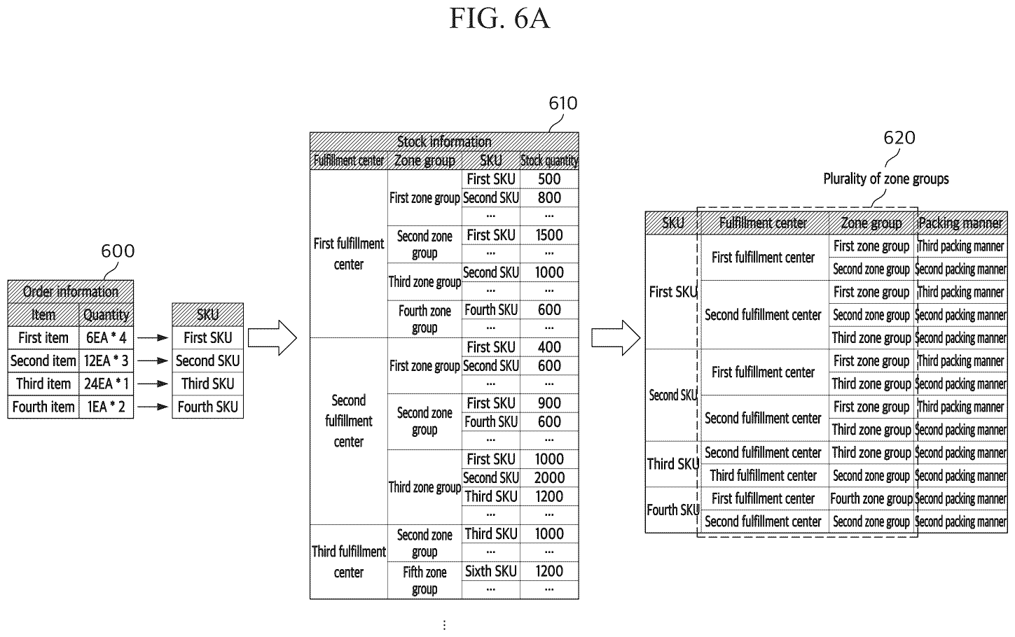

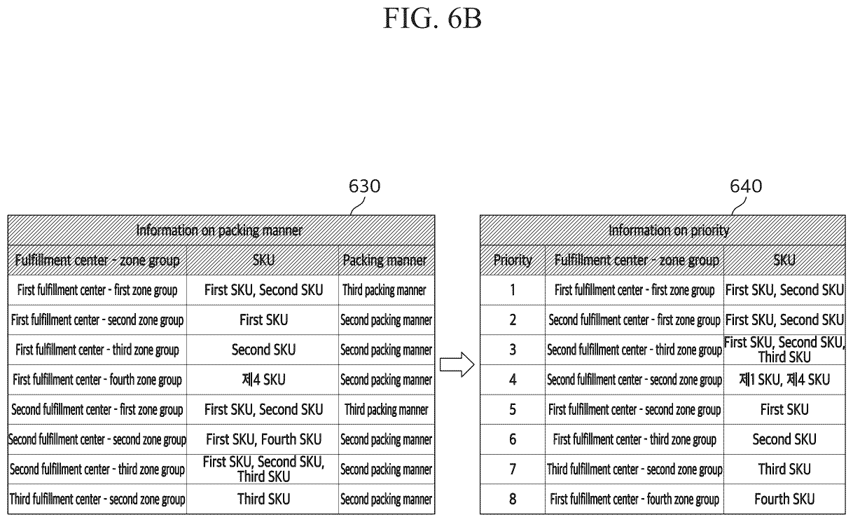

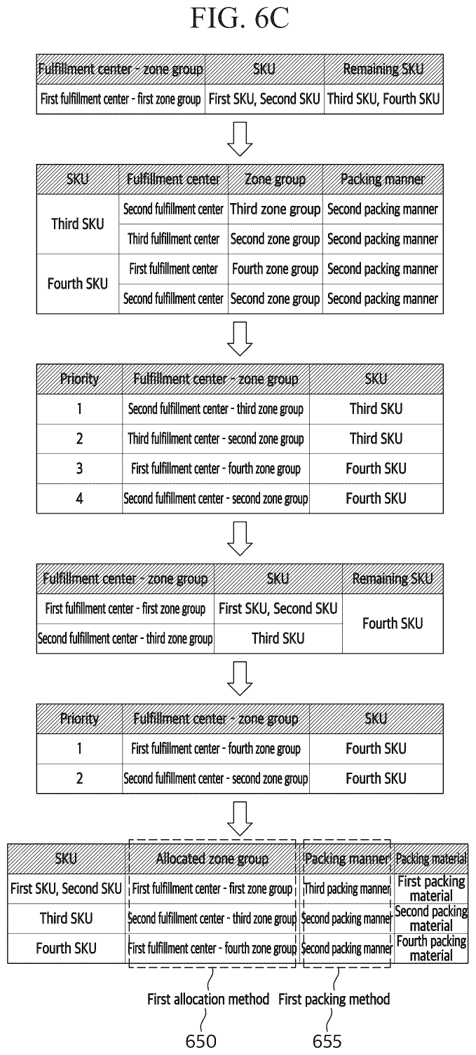

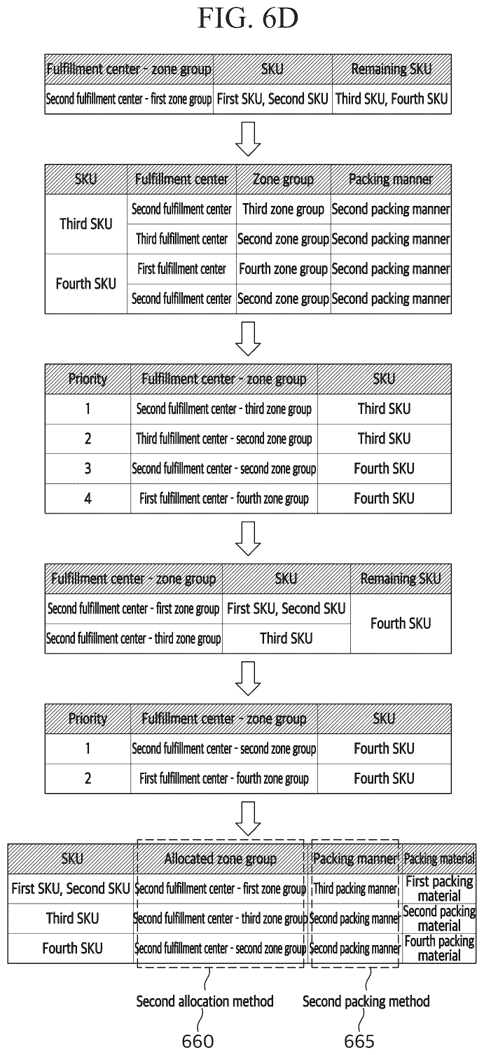

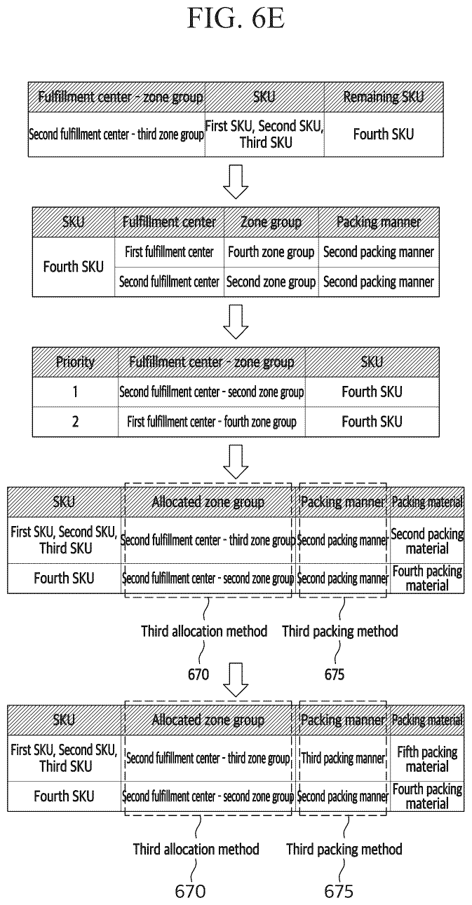

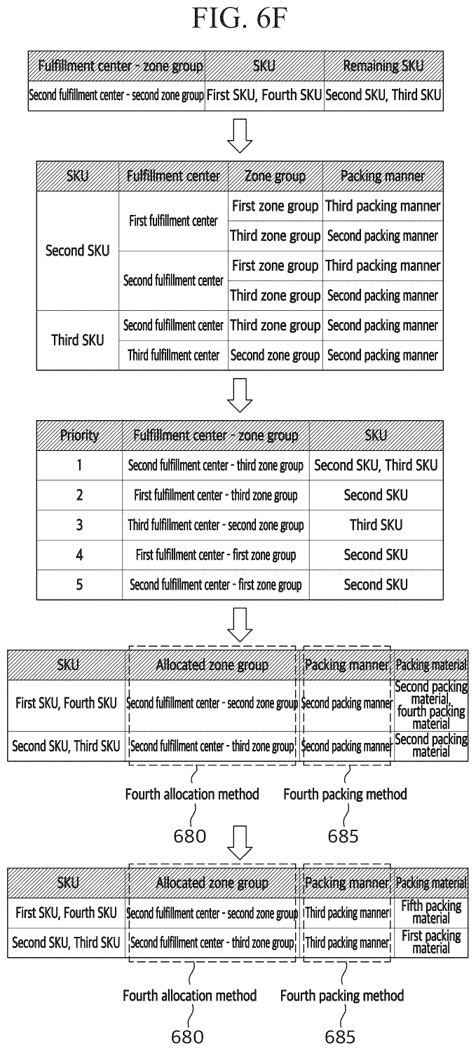

FIGS. 6A to 6F are diagrams for illustrating a process of determining an allocation method of one or more SKUs and a packing method of one or more SKUs by the electronic apparatus 100 according to an example embodiment.

According to an example embodiment, the electronic apparatus 100 may obtain information on a first order including information on one or more items. For example, referring to FIG. 6A, the electronic apparatus 100 may receive order information 600 including information on ordering 4 bundles of 6 of a first item, ordering 3 bundles of 12 of a second item, ordering 1 bundle of 24 of a third item, and ordering 2 of a fourth item from the user terminal 110.

According to an example embodiment, the electronic apparatus 100 may identify one or more SKUs corresponding to one or more items included in order information. For example, referring to FIG. 6A, the electronic apparatus 100 may identify a first SKU in which 6 of the first items are grouped and managed, a second SKU in which 12 of the second items are grouped and managed, a third SKU in which 24 of the third items are grouped and managed, and a fourth SKU in which the fourth item is individually managed.

According to an example embodiment, based on stock information of zone groups within a plurality of fulfillment centers, the electronic apparatus 100 may identify a plurality of zone groups having in stock the one or more SKUs among the zone groups. For example, referring to FIG. 6A, the electronic apparatus 100 may identify a plurality of zone groups 620 with the first SKU, the second SKU, the third SKU, and the fourth SKU based on stock information 610 of zone groups within a plurality of fulfillment centers.

According to an example embodiment, the electronic apparatus 100 may determine priorities of the plurality of zone groups based on information on a packing manner set for the plurality of zone groups and stock information of the plurality of zone groups.

For example, referring to FIGS. 6A and 6B, the electronic apparatus 100, based on information 630 on a packing manner set for the plurality of zone groups and the stock information 610 of the plurality of zone groups, may identify that a packing manner of a first fulfillment center—a first zone group and a second fulfillment center—the first zone group is set as the third packing manner and the number of types of SKUs in stock is 2 or more. Accordingly, the electronic apparatus 100 may assign the highest priority to the first fulfillment center—the first zone group and the second fulfillment center—the first zone group. Since the first fulfillment center—the first zone group and the second fulfillment center—the first zone group have identical priorities based on the first criterion, the electronic apparatus 100 may determine priorities of the first SKU and the second SKU based on the second criterion. However, since the number of types of SKUs in stock in the first fulfillment center—the first zone group and the second fulfillment center—the first zone group is 2, identical, so priorities are also identical based on the second criterion, the electronic apparatus 100 may determine the priority of the first fulfillment center—the first zone group (stock quantity of the first SKU: 500, stock quantity of the second SKU: 800) having more stocks of the one or more SKUs as 1 and may determine the priority of the second fulfillment center—the first zone group (stock quantity of the first SKU: 400, stock quantity of the second SKU: 600) as 2 based on the third criterion.

In addition, since the first fulfillment center—a second zone group, the first fulfillment center—a third zone group, the first fulfillment center—a fourth zone group, the second fulfillment center—the second zone group, the second fulfillment center—the third zone group, and a third fulfillment center—the second zone group have identical priorities based on the first criterion, the electronic apparatus 100 may determine the priority of the second fulfillment center—the third zone group of which the number of types of SKUs in stock is 3, the most, as 3 and determine the priority of the second fulfillment center—the second zone group of which the number of types of SKUs in stock is 2, the second most, as 4 based on the second criterion.

In addition, since the number of types of SKUs in stock in the first fulfillment center—the second zone group, the first fulfillment center—the third zone group, the first fulfillment center—the fourth zone group, and the third fulfillment center—the second zone group is 1, identical, so priorities are also identical based on the second criterion, the electronic apparatus 100 may determine the priority of the first fulfillment center—the second zone group (stock quantity of the first SKU: 1500) having most stocks of the one or more SKUs as 5 and determine the priority of the first fulfillment center—the fourth zone group (stock quantity of the fourth SKU: 600) having least stocks of the one or more SKUs as 8 based on the third criterion.

In addition, since the first fulfillment center—the third zone group (stock quantity of the second SKU: 1000) and the third fulfillment center—the second zone group (stock quantity of the third SKU: 1000) have identical stocks of the one or more SKUs and have identical priorities based on the third criterion, the electronic apparatus 100 may determine the priority of the first fulfillment center—the third zone group falling within an identical fulfillment center with the first fulfillment center—the first zone group of the highest priority as 6 based on the fourth criterion and determine the priority of the third fulfillment center—the second zone group as 7.

According to an example embodiment, the electronic apparatus 100 may identify a set first number of zone groups with the highest priority among the plurality of zone groups. For example, referring to FIG. 6B, the electronic apparatus 100 may identify 4 zone groups with the highest priority among the plurality of zone groups, the first fulfillment center—the first zone group, the second fulfillment center—the first zone group, the second fulfillment center—the third zone group, and the second fulfillment center—the second zone group, based on information 640 on priority.

According to an example embodiment, the electronic apparatus 100 may allocate the one or more SKUs to each of the set first number of zone groups with priority and determine a set first number of allocation methods and a set first number of packing methods.

For example, referring to FIG. 6C, the electronic apparatus 100 may allocate the one or more SKUs to the first fulfillment center—the first zone group with the highest priority. As it is identified that the first fulfillment center—the first zone group has no stock of the third SKU and the fourth SKU, the electronic apparatus 100 may identify the second fulfillment center—the third zone group, the third fulfillment center—the second zone group, the first fulfillment center—the fourth zone group, and the second fulfillment center—the second zone group having the third SKU and the fourth SKU in stock. The electronic apparatus 100 may, based on the information 630 on the packing manner set for each of the second fulfillment center—the third zone group, the third fulfillment center—the second zone group, the first fulfillment center—the fourth zone group, and the second fulfillment center—the second zone group and the stock information 610, determine the priority of the second fulfillment center—the third zone group having most stock quantity of the third SKU and the fourth SKU as 1 based on the third criterion. Subsequently, the electronic apparatus 100 may allocate the third SKU to the second fulfillment center—the third zone group, and as it is identified that the second fulfillment center—the third zone group has no stock of the fourth SKU, the electronic apparatus 100 may identify the first fulfillment center—the fourth zone group and the second fulfillment center—the second zone group having the fourth SKU in stock. The electronic apparatus 100 may, based on the information 630 on the packing manner set for each of the first fulfillment center—the fourth zone group and the second fulfillment center—the second zone group and the stock information 610, determine the priority of the first fulfillment center—the fourth zone group falling within an identical fulfillment center with the first fulfillment center—the first zone group as 1 based on the fourth criterion. Subsequently, the electronic apparatus 100 may identify that all of the one or more SKUs are allocated as the fourth SKU is allocated to the first fulfillment center—the fourth zone group. Accordingly, the electronic apparatus 100 may determine a first allocation method 650 and a first packing method 655 so that the first SKU and the second SKU are allocated to the first fulfillment center—the first zone group and packed by the third packing manner, the third SKU is allocated to the second fulfillment center—the third zone group and packed by the second packing manner, and the fourth SKU is allocated to the first fulfillment center—the fourth zone group and packed by the second packing manner.

For another example, referring to FIG. 6D, the electronic apparatus 100 may allocate the one or more SKUs to the second fulfillment center—the first zone group with the second highest priority. As it is identified that the first fulfillment center—the first zone group has no stock of the third SKU and the fourth SKU, the electronic apparatus 100 may identify the second fulfillment center—the third zone group, the third fulfillment center—the second zone group, the first fulfillment center—the fourth zone group, and the second fulfillment center—the second zone group having the third SKU and the fourth SKU in stock. The electronic apparatus 100 may, based on the information 630 on the packing manner set for each of the second fulfillment center—the third zone group, the third fulfillment center—the second zone group, the first fulfillment center—the fourth zone group, and the second fulfillment center—the second zone group and the stock information 610, determine the priority of the second fulfillment center—the third zone group having most stock quantity of the third SKU and the fourth SKU as 1 based on the third criterion. Subsequently, the electronic apparatus 100 may allocate the third SKU to the second fulfillment center—the third zone group, and as it is identified that the second fulfillment center—the third zone group has no stock of the fourth SKU, the electronic apparatus 100 may identify the first fulfillment center—the fourth zone group and the second fulfillment center—the second zone group having the fourth SKU in stock. The electronic apparatus 100 may, based on the information 630 on the packing manner set for each of the first fulfillment center—the fourth zone group and the second fulfillment center—the second zone group and the stock information 610, determine the priority of the second fulfillment center—the second zone group falling within an identical fulfillment center with the second fulfillment center—the first zone group as 1 based on the fourth criterion. Subsequently, the electronic apparatus 100 may identify that all of the one or more SKUs are allocated as the fourth SKU is allocated to the second fulfillment center—the second zone group. Accordingly, the electronic apparatus 100 may determine a second allocation method 660 and a second packing method 665 so that the first SKU and the second SKU are allocated to the second fulfillment center—the first zone group and packed by the third packing manner, the third SKU is allocated to the second fulfillment center—the third zone group and packed by the second packing manner, and the fourth SKU is allocated to the second fulfillment center—the second zone group and packed by the second packing manner.

For another example, referring to FIG. 6E, the electronic apparatus 100 may allocate the one or more SKUs to the second fulfillment center—the third zone group with the third highest priority. As it is identified that the second fulfillment center—the third zone group has no stock of the fourth SKU, the electronic apparatus 100 may identify the first fulfillment center—the fourth zone group and the second fulfillment center—the second zone group having the fourth SKU in stock. The electronic apparatus 100 may, based on the information 630 on the packing manner set for each of the first fulfillment center—the fourth zone group and the second fulfillment center—the second zone group and the stock information 610, determine the priority of the second fulfillment center—the second zone group falling within an identical fulfillment center with the second fulfillment center—the third zone group as 1 based on the fourth criterion. Subsequently, the electronic apparatus 100 may identify that all of the one or more SKUs are allocated as the fourth SKU is allocated to the second fulfillment center—the second zone group. Accordingly, the electronic apparatus 100 may determine a third allocation method 670 and a third packing method 675 so that the first SKU, the second SKU, and the third SKU are allocated to the second fulfillment center—the third zone group and packed by the second packing manner and the fourth SKU is allocated to the second fulfillment center—the second zone group and packed by the second packing manner. However, the electronic apparatus 100 may identify that, when the one or more SKUs are packed based on the third packing method 675, the number of parcels provided from the second fulfillment center is 10, which is greater than a consolidated packing threshold value of the second fulfillment center, 5. Accordingly, the electronic apparatus 100 may change the third packing method 675 to pack the first SKU, the second SKU, and the third SKU allocated to the second fulfillment center—the third zone group by the third packing manner. As a result, the number of parcels provided from the second fulfillment center may be changed into 3, which is less than the consolidated packing threshold value of the second fulfillment center.

For another example, referring to FIG. 6F, the electronic apparatus 100 may allocate the one or more SKUs to the second fulfillment center—the second zone group with the fourth highest priority. As it is identified that the second fulfillment center—the second zone group has no stock of the second SKU and the third SKU, the electronic apparatus 100 may identify the first fulfillment center—the first zone group, the first fulfillment center—the third zone group, the second fulfillment center—the first zone group, the second fulfillment center—the third zone group, and the third fulfillment center—the second zone group having the second SKU and the third SKU in stock. The electronic apparatus 100 may, based on the information 630 on the packing manner set for each of the first fulfillment center—the first zone group, the first fulfillment center—the third zone group, the second fulfillment center—the first zone group, the second fulfillment center—the third zone group, and the third fulfillment center—the second zone group and the stock information 610, determine the priority of the second fulfillment center—the third zone group in which the number of types in stock is most as 1 based on the second criterion. Subsequently, the electronic apparatus 100 may identify that all of the one or more SKUs are allocated as the second SKU and the third SKU are allocated to the second fulfillment center—the third zone group. Accordingly, the electronic apparatus 100 may determine a fourth allocation method 680 and a fourth packing method 685 so that the first SKU and the fourth SKU are allocated to the second fulfillment center—the second zone group and packed by the second packing manner and the second SKU and the third SKU are allocated to the second fulfillment center—the third zone group and packed by the second packing manner. However, the electronic apparatus 100 may identify that, when the one or more SKUs are packed based on the fourth packing method 685, the number of parcels provided from the second fulfillment center is 10, which is greater than the consolidated packing threshold value of the second fulfillment center, 5. Accordingly, the electronic apparatus 100 may change the fourth packing method 685 to pack the first SKU and the fourth SKU allocated to the second fulfillment center—the second zone group by the third packing manner and pack the second SKU and the third SKU allocated to the second fulfillment center—the third zone group by the third packing manner. As a result, the number of parcels provided from the second fulfillment center may be changed into 2, which is less than the consolidated packing threshold value of the second fulfillment center.

According to an example embodiment, the electronic apparatus 100 may determine a plurality of allocation methods and a plurality of packing methods among the set first number of allocation methods and the set first number of packing methods. More specifically, the electronic apparatus 100 may determine the set first number of allocation methods and the set first number of packing methods as the plurality of allocation methods and the plurality of packing methods or determine a set second number of allocation methods and a set second number of packing methods of which the number of corresponding parcels is the least among the set first number of allocation methods and the set first number of packing methods as the plurality of allocation methods and the plurality of packing methods.

For example, the electronic apparatus 100 may identify that the number of parcels corresponding to the first allocation method 650 and the first packing method 655 is 4, the number of parcels corresponding to the second allocation method 660 and the second packing method 665 is 4, the number of parcels corresponding to the third allocation method 670 and the third packing method 675 is 3, and the number of parcels corresponding to the fourth allocation method 680 and the fourth packing method 685 is 2. Subsequently, the electronic apparatus 100 may select two, of which the number of corresponding parcels is the least, the third allocation method 670 and the third packing method 675 and the fourth allocation method 680 and the fourth packing method 685.

According to an example embodiment, the electronic apparatus 100 may select one allocation method and a corresponding packing method among the plurality of allocation methods and the plurality of packing methods. More specifically, the electronic apparatus 100 may select one allocation method and the corresponding packing method among the plurality of allocation methods and the plurality of packing methods based on an input of a manager, information on the number of parcels, information on a priority of a fulfillment center, or information on estimated cost.

For example, the electronic apparatus 100 may select the fourth allocation method 680 and the fourth packing method 685 of which the number of corresponding parcels is the least.

According to an example embodiment, the electronic apparatus 100 may allocate the one or more SKUs based on a selected allocation method. For example, the electronic apparatus 100 may allocate the first SKU and the fourth SKU to the second fulfillment center—the second zone group and the second SKU and the third SKU to the second fulfillment center—the third zone group based on the fourth allocation method 680.

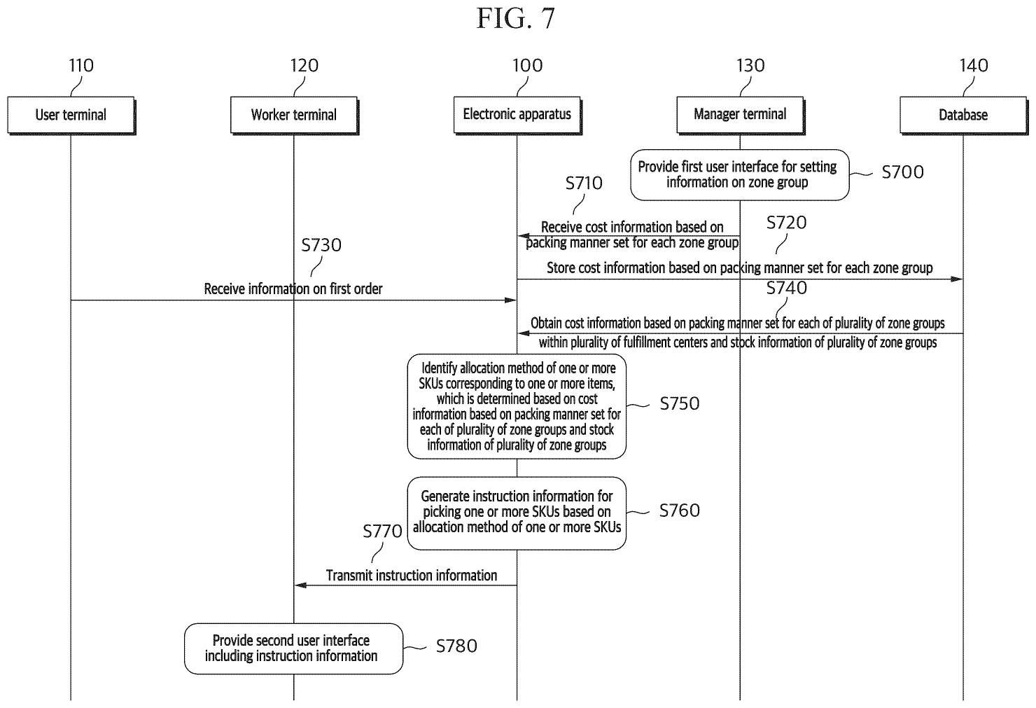

FIG. 7 is a diagram for illustrating a process of generating instruction information for picking one or more SKUs by the electronic apparatus 100 according to an example embodiment.

In operation S700, the manager terminal 130 may provide a first user interface for setting information on a zone group according to an example embodiment. For example, the manager terminal 130 may display the first user interface for setting cost information based on a packing manner for each zone group of different types on a display based on information received from the electronic apparatus 100.

Meanwhile, a detailed example of the first user interface for setting the information on the zone group is described in detail with reference to FIGS. 10A to 10B.

In operation S710, the electronic apparatus 100 may receive cost information based on the packing manner set for each zone group from the manager terminal 130 according to an example embodiment. For example, the manager terminal 130 may obtain input from a manager for setting cost information based on a first packing manner of packing SKUs individually, a second packing manner of packing an identical type of SKUs together, and a third packing manner of packing different types of SKUs together for each of a first-type zone group, a second-type zone group, a third-type zone group, a fourth-type zone group, a fifth-type zone group, and a sixth-type zone group through the first user interface. Subsequently, the manager terminal 130 may transmit the cost information based on the packing manner set for each zone group inputted by the manager to the electronic apparatus 100.

In operation S720, the electronic apparatus 100 may store the cost information based on the packing manner set for each zone group in the database 140 according to an example embodiment. For example, the electronic apparatus 100 may store the cost information based on the packing manner set for each zone group in the database 140 as the cost information based on the packing manner set for each zone group is received from the manager terminal 130.

In operation S730, the electronic apparatus 100 may receive information on a first order including information on one or more items from the user terminal 110 according to an example embodiment. For example, the user terminal 110 may transmit order information including information on one or more items ordered by a user and information on a delivery location to the electronic apparatus 100.

In operation S740, the electronic apparatus 100 may obtain cost information based on a packing manner set for each of a plurality of zone groups within a plurality of fulfillment centers and stock information of the plurality of zone groups from the database 140 according to an example embodiment. For example, as the information on the first order is obtained, the electronic apparatus 100 may identify the cost information based on the packing manner set for each of the plurality of zone groups and the stock information of the plurality of zone groups stored in the database 140.

In operation S750, the electronic apparatus 100 may identify an allocation method of one or more SKUs corresponding to the one or more items, which is determined based on the cost information based on the packing manner set for each of the plurality of zone groups and the stock information of the plurality of zone groups according to an example embodiment. For example, based on the stock information of the plurality of zone groups, the electronic apparatus 100 may identify one or more zone groups having in stock the one or more SKUs among the plurality of zone groups. Subsequently, the electronic apparatus 100, based on the cost information based on the packing manner set for each of the plurality of zone groups, may determine the allocation method of the one or more SKUs to at least one zone group among the one or more zone groups to minimize picking and packing costs of the one or more SKUs.

In operation S760, the electronic apparatus 100 may generate instruction information for picking the one or more SKUs based on the allocation method of the one or more SKUs according to an example embodiment. For example, the electronic apparatus 100 may generate first instruction information for picking a first SKU among the one or more SKUs from a first zone group, second instruction information for picking a second SKU among the one or more SKUs from a second zone group, and third instruction information for picking a third SKU among the one or more SKUs from a third zone group.

According to an example embodiment, the electronic apparatus 100 may generate instruction information for picking at least some of the one or more SKUs differently from the allocation method of the one or more SKUs based on information on a processing capacity of the plurality of zone groups. For example, the electronic apparatus 100 may identify that the first SKU may not be processed in the first zone group based on the information on the processing capacity of the plurality of zone groups. Accordingly, the electronic apparatus 100 may generate instruction information for picking the first SKU from a zone group of an identical type with the first zone group within a different fulfillment center from the first zone group.

According to an example embodiment, the electronic apparatus 100 may generate instruction information for picking at least some of the one or more SKUs differently from the allocation method of the one or more SKUs based on information indicating that an SKU is damaged. For example, the electronic apparatus 100 may identify information indicating that the second SKU arranged in the second zone group is damaged. Accordingly, the electronic apparatus 100 may generate instruction information for picking the second SKU from a zone group of a different type from the second zone group based on the cost information based on the packing manner set for each of the plurality of zone groups and the stock information of the plurality of zone groups.

According to an example embodiment, the electronic apparatus 100 may generate instruction information for picking at least some of the one or more SKUs differently from the allocation method of the one or more SKUs based on information indicating that an SKU is not in stock. For example, the electronic apparatus 100 may identify information indicating that the third zone group has no stock of the third SKU. Accordingly, the electronic apparatus 100 may generate instruction information for picking the third SKU from a zone group of a different type from the third zone group based on the cost information based on the packing manner set for each of the plurality of zone groups and the stock information of the plurality of zone groups.

In operation S770, the electronic apparatus 100 may transmit the instruction information to the worker terminal 120 according to an example embodiment. For example, the electronic apparatus 100 may transmit the instruction information for picking the one or more SKUs in a form that may be displayed on a web page or an application screen to the worker terminal 120.

In operation S780, the worker terminal 120 may provide a second user interface including the instruction information according to an example embodiment. For example, the worker terminal 120 may display the second user interface including the instruction information for picking the one or more SKUs on a display based on information received from the electronic apparatus 100.

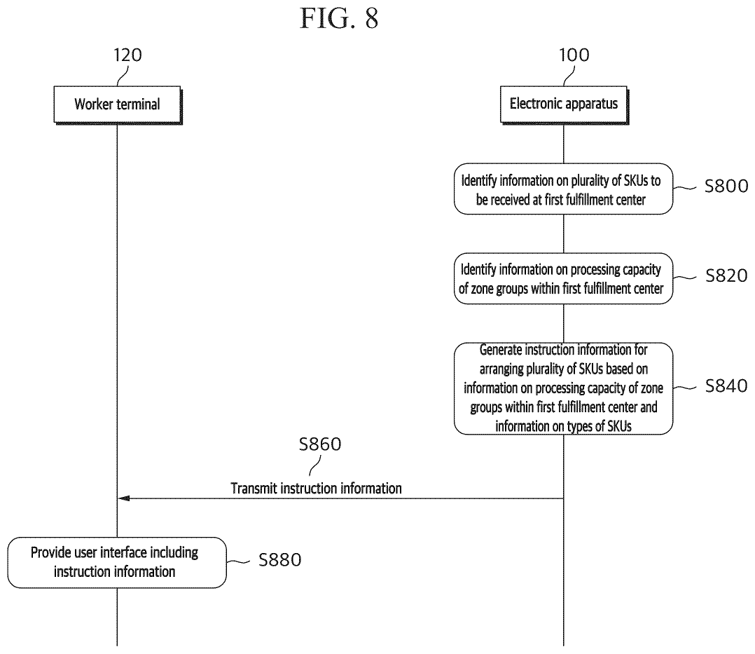

FIG. 8 is a diagram for illustrating a process of generating instruction information for arranging one or more SKUs by the electronic apparatus 100 according to an example embodiment.

In operation S800, the electronic apparatus 100 may identify information on a plurality of SKUs to be received at a first fulfillment center according to an example embodiment. For example, the electronic apparatus 100 may receive the information on the plurality of SKUs to be received at the first fulfillment center from the manager terminal 130.

In operation S820, the electronic apparatus 100 may identify information on a processing capacity of zone groups within the first fulfillment center according to an example embodiment. More specifically, the electronic apparatus 100 may identify a processing capacity of a first zone group based on a first time point, a calculated time point of the processing capacity of the first zone group, and a release capacity of the first zone group.

For example, the electronic apparatus 100 may obtain the processing capacity of the first zone group by multiplying the release capacity of the first zone group and a preset scaling value by a value of subtracting a pre-work time from a difference between the first time point and the calculated time point of the processing capacity of the first zone group.

In this case, the pre-work time may commonly refer to a time required for pre-work such as picking and packing SKUs before the SKUs is released. For example, the pre-work time may include at least a portion of a picking time for picking SKUs and a packing time for packing SKUs. In addition, the release capacity denotes the maximum number of SKUs that may be processed in the first zone group during a determined time and may be obtained by multiplying the number of available picking worktables within the first zone group by a productivity value set for each worktable uniformly. Meanwhile, the scaling value may be set in a range of 0.5 or more and 2.0 or less, although not particularly limited.

In operation S840, the electronic apparatus 100 may generate instruction information for arranging the plurality of SKUs based on the information on the processing capacity of zone groups within the first fulfillment center and information on types of SKUs according to an example embodiment.

For example, the electronic apparatus 100 may generate second instruction information for arranging the plurality of SKUs in at least one of a first-type zone group, a second-type zone group, a third-type zone group, a fourth-type zone group, a fifth-type zone group, and a sixth-type zone group based on the information on the processing capacity of zone groups within the first fulfillment center.

For another example, the electronic apparatus 100 may generate instruction information for arranging a first-type SKU frequently purchased by users among the plurality of SKUs in the four-type zone group and arranging a second-type SKU and a third-type SKU frequently purchased together by users in the fifth-type zone group.

According to an example embodiment, the electronic apparatus 100 may forecast a stock demand and generate the instruction information for arranging the plurality of SKUs based on information on the forecast stock demand. For example, the electronic apparatus 100 may analyze purchasing patterns of users using a predictive analytics model or a machine learning model and determine an expected demand quantity according thereto. Subsequently, the electronic apparatus 100 may generate the instruction information for arranging the plurality of SKUs based on information on the determined expected demand quantity.

Accordingly, by strategically positioning SKUs for workers to pick high-demand SKUs faster, a calculation load for real-time adjustment may be reduced, and delivery error possibility may decrease and simultaneously delivery prediction accuracy may be enhanced.

In operation S860, the electronic apparatus 100 may transmit the instruction information to the worker terminal 120 according to an example embodiment. For example, the electronic apparatus 100 may transmit the instruction information for arranging the plurality of SKUs in a form that may be displayed on a web page or an application screen to the worker terminal 120.

In operation S880, the worker terminal 120 may provide a user interface including the instruction information according to an example embodiment. The worker terminal 120 may display the user interface including the instruction information for arranging the plurality of SKUs on a display based on information received from the electronic apparatus 100.

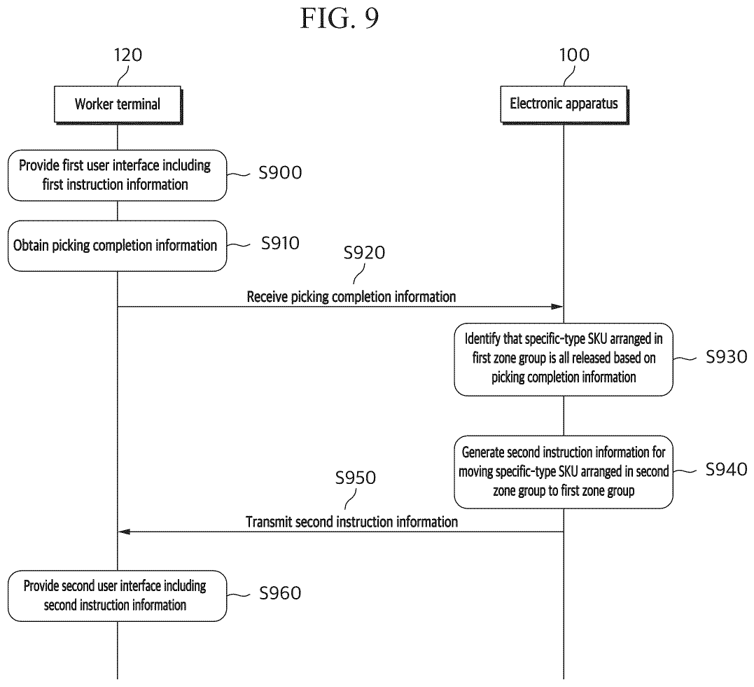

FIG. 9 is a diagram for illustrating a process of generating instruction information for moving one or more SKUs by the electronic apparatus 100 according to an example embodiment.

In operation S900, the worker terminal 120 may provide a first user interface including first instruction information according to an example embodiment. For example, the worker terminal 120 may display the first user interface including the first instruction information for picking one or more SKUs within a first fulfillment center on a display based on information received from the electronic apparatus 100.

In operation S910, the worker terminal 120 may obtain picking completion information according to an example embodiment. For example, the worker terminal 120 may obtain input indicating that the one or more SKUs are picked based on the first instruction information from a worker.

In operation S920, the electronic apparatus 100 may receive the picking completion information from the worker terminal 120 according to an example embodiment. For example, as the picking completion information is obtained, the worker terminal 120 may transmit information indicating that the one or more SKUs are picked based on the first instruction information to the electronic apparatus 100.

In operation S930, the electronic apparatus 100 may identify that a specific-type SKU arranged in a first zone group is all released based on the picking completion information according to an example embodiment. For example, the electronic apparatus 100 may identify that the specific-type SKU arranged in the first zone group is all released based on information indicating that the specific-type SKU arranged in the first zone group is picked by a worker and stock information of zone groups within a first fulfillment center.

In operation S940, the electronic apparatus 100 may generate second instruction information for moving the specific-type SKU arranged in a second zone group to the first zone group according to an example embodiment. More specifically, based on information on priorities between zone groups, set differently for each SKU type, the electronic apparatus 100 may generate the second instruction information for moving the specific-type SKU.

For example, the specific-type SKU may be a first-type SKU frequently purchased by users, and the first zone group may be a fourth-type zone group or Fast Forward zone group where the first-type SKU is arranged. In this case, the electronic apparatus 100 may identify that the fourth-type zone group has a highest priority with regard to the first-type SKU and generate instruction information for moving the first-type SKU arranged in at least one of a first-type zone group, a second-type zone group, a third-type zone group, a fifth-type zone group, and a sixth-type zone group within the first fulfillment center to the first zone group.

For another example, the specific-type SKU may be a second-type SKU or a third-type SKU frequently purchased together by users, and the first zone group may be the fifth-type zone group or Multi-Manual zone group where the second-type SKU and the third-type SKU are arranged. In this case, the electronic apparatus 100 may identify that the fifth-type zone group has a highest priority with regard to the second-type SKU or the third-type SKU and generate instruction information for moving the second-type SKU or the third-type SKU arranged in at least one of the first-type zone group, the second-type zone group, the third-type zone group, the fourth-type zone group, and the sixth-type zone group within the first fulfillment center to the first zone group.

In operation S950, the electronic apparatus 100 may transmit the second instruction information to the worker terminal 120 according to an example embodiment. For example, the electronic apparatus 100 may transmit the second instruction information for moving the specific-type SKU arranged in the second zone group to the first zone group in a form that may be displayed on a web page or an application screen to the worker terminal 120.

In operation S960, the worker terminal 120 may provide a second user interface including the second instruction information according to an example embodiment. The worker terminal 120 may display the second user interface including the second instruction information for moving the specific-type SKU arranged in the second zone group to the first zone group on a display based on information received from the electronic apparatus 100.

FIGS. 10A to 10B illustrate an example of a user interface provided by the electronic apparatus 100 according to an example embodiment.

According to an example embodiment, the electronic apparatus 100 may provide a user interface including a list of a plurality of zones within a first fulfillment center. For example, the electronic apparatus 100 may transmit information on the plurality of zones within the first fulfillment center in a form that may be displayed on a web page or an application screen to the worker terminal 120. Subsequently, referring to FIG. 10A, the worker terminal 120 may display a user interface 1000 including an area 1010 displaying the list of the plurality of zones on a display.

According to an example embodiment, the electronic apparatus 100 may identify a type of a zone group corresponding to each of the plurality of zones based on information inputted by a manager through the user interface. For example, referring to FIG. 10A, when the manager selects a down arrow icon within an area 1020 or positions a cursor within the area 1020, the electronic apparatus 100 may provide a pull-down menu or a drop-down list including a list of zone group types. Subsequently, “Pre-pack” selected by the manager may be displayed in the area 1020, and as the manager selects one or more zones in the area 1010, a type of a zone group corresponding to the selected one or more zones may be set as a Pre-pack zone group or a third type.

According to an example embodiment, the electronic apparatus 100 may provide information on a recommended type of a zone group corresponding to a zone selected by the manager. For example, referring to FIG. 10A, as the manager selects 51D icon within the area 1010 or positions a cursor over 51D icon, a pop-up window 1030 including information on Fast Forward zone group and Pre-pack zone group as zone groups of types suitable for 51D zone to be included in may be displayed.

Meanwhile, the electronic apparatus 100 may determine a zone suitable to be included in a zone group of a type selected by the manager based on at least one of first information about a distance from the plurality of zones to a conveyor belt, second information about the number of available picking worktables within the plurality of zones, third information about hourly productivity of the available picking worktables within the plurality of zones, and fourth information about whether an AGV is present within the plurality of zones or not.

For example, the electronic apparatus 100 may determine a recommended type of a zone group corresponding to a zone with a short distance to a conveyor belt as a fourth type or Fast Forward zone group. Alternatively, the electronic apparatus 100 may determine a recommended type of a zone group corresponding to a zone with many available picking worktables or a zone with high hourly productivity of the available picking worktables as a fifth type or Multi-Manual zone group. The electronic apparatus 100 may determine a recommended type of a zone group corresponding to a zone where an AGV is present as a second type or AGV zone group.

According to an example embodiment, the electronic apparatus 100 may recommend a zone corresponding to a zone group type selected by the manager. For example, referring to FIG. 10A, as the manager selects Pre-pack in the area 1020, the electronic apparatus 100 may identify zones of which a first recommended type of a corresponding zone group among the plurality of zones within the first fulfillment center is Pre-pack zone group or the third type. Subsequently, information on 21D, 21K, 21O, 21P, 21R, 21U, 22D, 22K, 22O, 22P, 43HA, 43HK, 43HLM 43HM, and 43HN, which are zones suitable to be included in a zone group of the third type may be displayed on an area 1040.

According to an example embodiment, the electronic apparatus 100 may identify cost information based on a packing manner set for each zone group type based on the information inputted by the manager through the user interface. For example, referring to FIG. 10B, the user interface 1000 may include an area 1050 for setting a cost based on a first packing manner, an area 1060 for setting a cost based on a second packing manner, and an area 1070 for setting a cost based on a third packing manner for the third-type zone group or Pre-pack zone group selected by the manager. Subsequently, as the manager selects costs in the area 1050, the area 1060, and the area 1070, the electronic apparatus 100 may identify cost information based on the first packing manner, cost information based on the second packing manner, and cost information based on the third packing manner corresponding to the third-type zone group.

In this case, the cost information based on the packing manner may be represented as values from 1 to 10, and a smaller value may indicate that a cost by packing manner is cheaper. In addition, as the manager selects a value of the cost information based on the first packing manner as 10, icons corresponding to 10 may be deactivated in the area 1060 and the area 1070.

Meanwhile, the detailed examples of the types of user interface components and the zones described above are merely an example embodiment, and it is apparent to those of ordinary skill in the art to which the present disclosure pertains that the present disclosure may be implemented as examples different from the above examples.

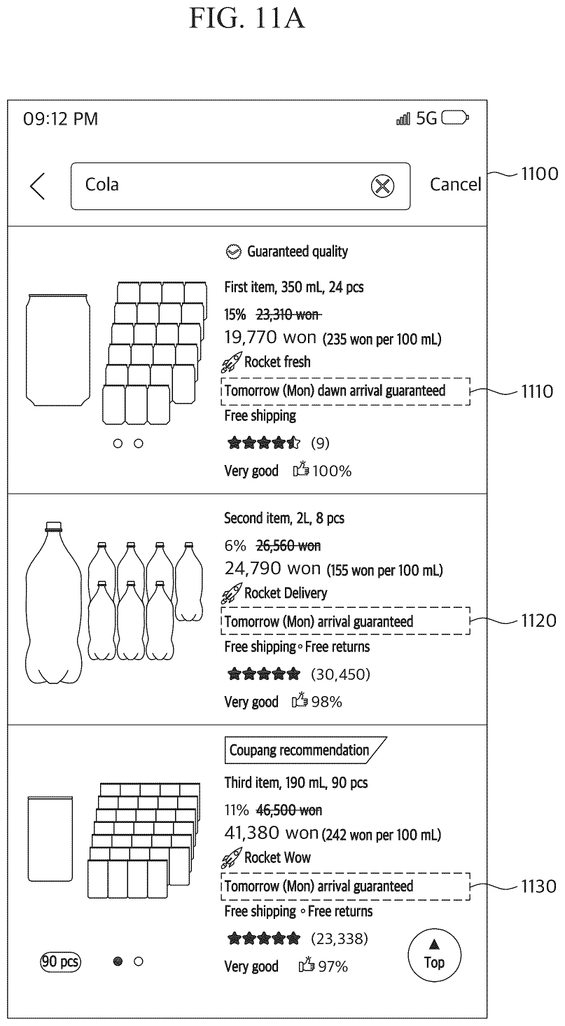

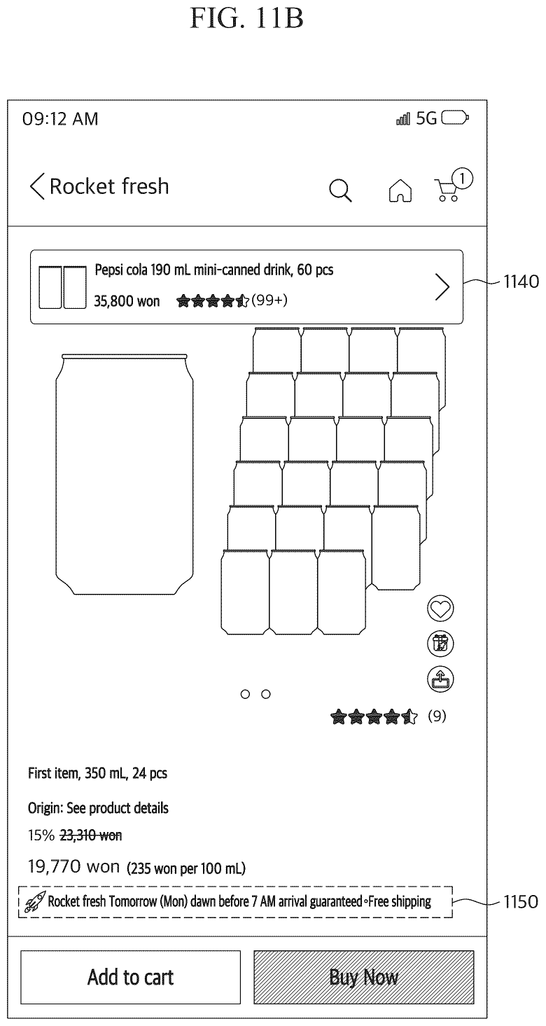

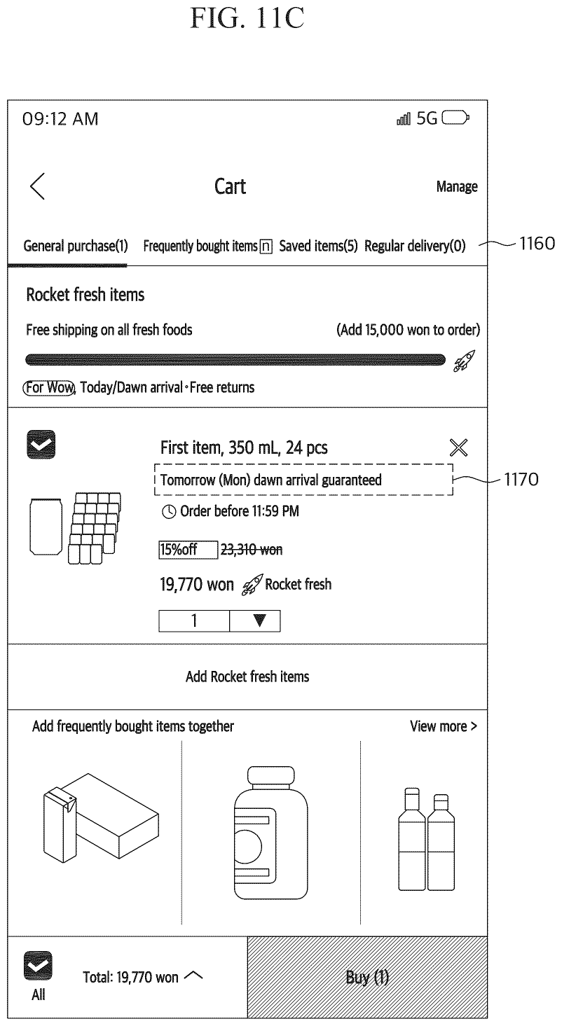

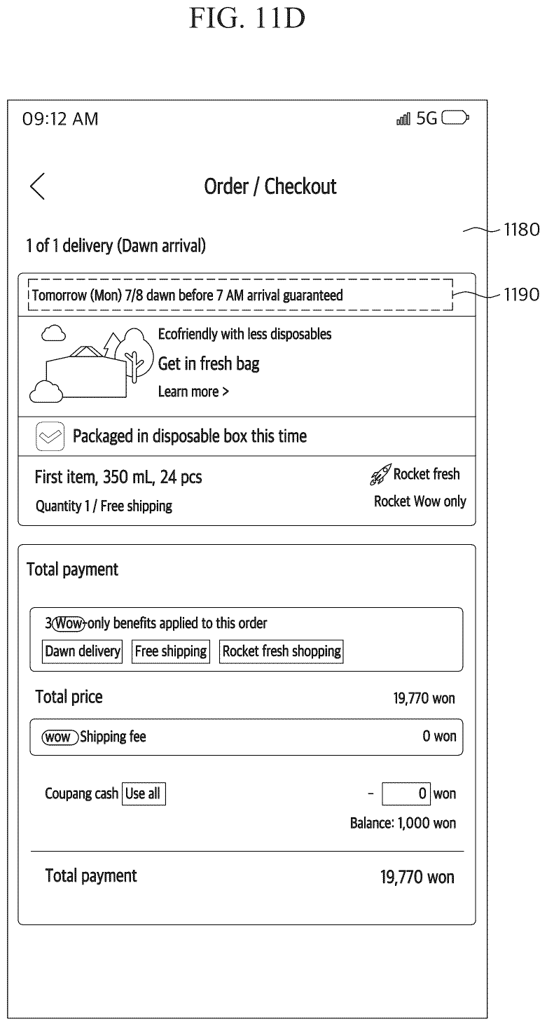

FIGS. 11A to 11D illustrate an example of a user interface provided by the electronic apparatus 100 according to an example embodiment.

According to an example embodiment, the electronic apparatus 100 may provide information on an expected time at which an ordered item may be received, that is, a PDD of an item. More specifically, the electronic apparatus 100 may receive a request for a first page including a request for information on a PDD of a first item from the user terminal 110. Subsequently, the electronic apparatus 100 may determine the PDD of the first item and transmit information on the first page including the information on the PDD of the first item to the user terminal 110. The user terminal 110 may display the first page including the information on the PDD of the first item on a display based on information received from the electronic apparatus 100.

For example, as a request for a search result page 1100 corresponding to Cola is received from the user terminal 110, the electronic apparatus 100 may identify a plurality of items corresponding to Cola. Subsequently, the electronic apparatus 100 may determine a PDD of each of the plurality of items and transmit information on the search result page 1100 including information on the PDD of each of the plurality of items to the user terminal 110. Accordingly, referring to FIG. 11A, the user terminal 110 may display the search result page 1100 including an area 1110 representing information that the PDD of the first item is dawn on a following day, an area 1120 representing information that a PDD of a second item is the following day, and an area 1130 representing information that a PDD of a third item is the following day on the display based on the information received from the electronic apparatus 100.

For another example, the electronic apparatus 100 may receive a request for a product detail page 1140 about the first item from the user terminal 110. Subsequently, the electronic apparatus 100 may determine the PDD of the first item and transmit information on the product detail page 1140 including the information on the PDD of the first item to the user terminal 110. Accordingly, referring to FIG. 11B, the user terminal 110 may display the product detail page 1140 including an area 1150 representing information that the PDD of the first item is dawn on the following day on the display based on the information received from the electronic apparatus 100.

For another example, the electronic apparatus 100 may receive a request for a cart page 1160 including the first item from the user terminal 110. Subsequently, the electronic apparatus 100 may determine the PDD of the first item and transmit information on the cart page 1160 including the information on the PDD of the first item to the user terminal 110. Accordingly, referring to FIG. 11C, the user terminal 110 may display the cart page 1160 including an area 1170 representing information that the PDD of the first item is dawn on the following day on the display based on the information received from the electronic apparatus 100.

For another example, the electronic apparatus 100 may receive a request for a payment page 1180 about the first item from the user terminal 110. Subsequently, the electronic apparatus 100 may determine the PDD of the first item and transmit information on the payment page 1180 including the information on the PDD of the first item to the user terminal 110. Accordingly, referring to FIG. 11D, the user terminal 110 may display the payment page 1180 including an area 1190 representing information that the PDD of the first item is dawn on the following day on the display based on the information received from the electronic apparatus 100.

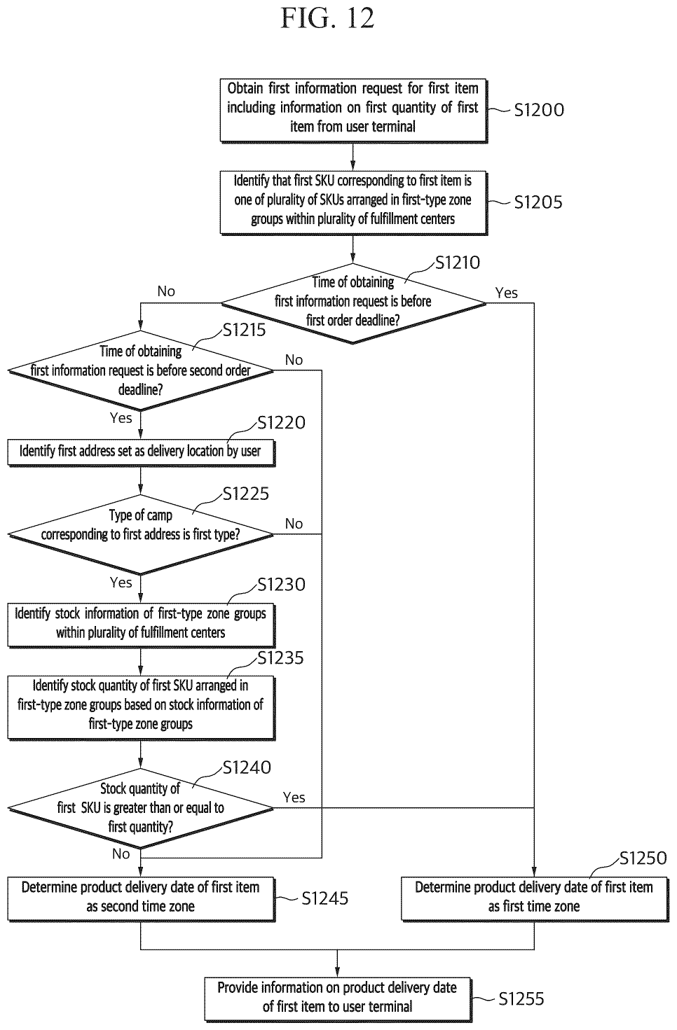

Meanwhile, the PDD of the item may be determined based on a type of an SKU corresponding to the item, an obtained time of a request for a page, a type of a camp corresponding to an address set as a delivery location by a user, or stock information of zone groups, and a detailed method of determining the PDD of the item is described below in more detail with reference to FIG. 12.

FIG. 12 is a diagram for illustrating a process of providing information on a product delivery date of an item by the electronic apparatus 100 according to an example embodiment.

In operation S1200, the electronic apparatus 100 may obtain a first information request for a first item including information on a first quantity of the first item from the user terminal 110 according to an example embodiment. For example, the user terminal 110 may obtain input from a user for adding 5 of the first items to a cart and transmit a request for a cart page to the electronic apparatus 100.

In operation S1205, the electronic apparatus 100 may identify that a first SKU corresponding to the first item is one of a plurality of SKUs arranged in first-type zone groups within a plurality of fulfillment centers according to an example embodiment. For example, as the request for the cart page is received from the user terminal 110, the electronic apparatus 100 may identify the first SKU corresponding to the first item added to the cart by the user. Subsequently, the electronic apparatus 100 may identify that the first SKU is a first-type SKU arranged in the first-type zone groups.

In this case, the first-type zone group may refer to Fast Forward zone group, and SKUs corresponding to a set number of items of which purchasing frequencies by users are highest may be arranged in a zone included in the first-type zone groups.

In operation S1210, the electronic apparatus 100 may identify whether a time of obtaining the first information request is before a first order deadline according to an example embodiment. For example, the electronic apparatus 100 may identify whether a time of receiving the first information request from the user terminal 110 is before 9 PM set as the first order deadline. When the time of obtaining the first information request is after the first order deadline, the electronic apparatus 100 may perform operation S1215, and when the time of obtaining the first information request is before the first order deadline, the electronic apparatus 100 may perform operation S1250.

In this case, the first order deadline may indicate an order deadline set for a zone group other than the first-type zone group and may be set to a different time from the above example. In addition, the time of obtaining the first information request may include a time at which the user terminal 110 obtains input from the user or a time at which the user terminal 110 transmits the first information request to the electronic apparatus 100, in addition to the time at which the electronic apparatus 100 receives the first information request from the user terminal 110, and is not limited to the above description.

In operation S1215, the electronic apparatus 100 may identify whether the time of obtaining the first information request is before a second order deadline according to an example embodiment. For example, as it is identified that the time of obtaining the first information request is after the first order deadline, the electronic apparatus 100 may identify whether the time of receiving the first information request from the user terminal 110 is before 11:59 PM set as the second order deadline. When the time of obtaining the first information request is before the second order deadline, the electronic apparatus 100 may perform operation S1220, and when the time of obtaining the first information request is after the second order deadline, the electronic apparatus 100 may perform operation S1245.

In this case, the second order deadline may indicate an order deadline set for the first-type zone group and may be set to a different time from the above example.

In operation S1220, the electronic apparatus 100 may identify a first address set as a delivery location by the user according to an example embodiment. For example, as it is identified that the time of obtaining the first information request is before the second order deadline, the electronic apparatus 100 may identify information on the first address set as the delivery location by the user, which is stored in the database 140.

In operation S1225, the electronic apparatus 100 may identify whether a type of a camp corresponding to the first address is a first type according to an example embodiment. For example, the electronic apparatus 100 may identify whether the camp corresponding to the first address set as the delivery location by the user is a camp of the first type. When the camp corresponding to the first address is the camp of the first type, the electronic apparatus 100 may perform operation S1230, and when the camp corresponding to the first address is not the camp of the first type, the electronic apparatus 100 may perform operation S1245.

In this case, the camp may be a final distribution facility for delivering items released from a fulfillment center to users, and a task of splitting items for each delivery area and distributing the items to delivery workers and a task of loading and unloading items may be performed in the camp. In addition, even when a user orders an item corresponding to the SKUs arranged in the first-type zone group after the first order deadline, the camp of the first type may indicate a camp that is designated so that a delivery task for delivering the item to the user at dawn on a following day is performed. Based on a size of a camp, a size of a delivery area corresponding to the camp, the number of delivery workers for the camp, and a daily average delivery volume processed in the camp, a set number of camps among a plurality of camps may be designated as the camp of the first type.

In operation S1230, the electronic apparatus 100 may identify stock information of the first-type zone groups within the plurality of fulfillment centers according to an example embodiment. For example, as it is identified that the type of the camp corresponding to the first address is the first type, the electronic apparatus 100 may identify the stock information of the first-type zone groups within the plurality of fulfillment centers, which is stored in the database 140.

In operation S1235, the electronic apparatus 100 may identify a stock quantity of the first SKU arranged in the first-type zone groups based on the stock information of the first-type zone groups according to an example embodiment. For example, the electronic apparatus 100 may identify how many stocks of the first SKU are arranged in the first-type zone groups based on the stock information of the first-type zone groups within the plurality of fulfillment centers.

In operation S1240, the electronic apparatus 100 may identify whether the stock quantity of the first SKU is greater than or equal to the first quantity according to an example embodiment. For example, the electronic apparatus 100 may identify whether the stock quantity of the first SKU arranged in the first-type zone groups is greater than or equal to 5, the number of the first item added to the cart by the user. When the stock quantity of the first SKU is less than the first quantity, the electronic apparatus 100 may perform operation S1245, and when the stock quantity of the first SKU is greater than or equal to the first quantity, the electronic apparatus 100 may perform operation S1250.

In operation S1245, the electronic apparatus 100 may determine a PDD of the first item as a second time zone according to an example embodiment. For example, when it is identified that the time of obtaining the first information request is after the second order deadline in operation S1215, when it is identified that the camp corresponding to the first address is not the camp of the first type in operation S1225, or when it is identified that the stock quantity of the first SKU is less than the first quantity in operation S1240, the electronic apparatus 100 may determine the PDD of the first item as a following day.

In operation S1250, the electronic apparatus 100 may determine the PDD of the first item as a first time zone according to an example embodiment. For example, when it is identified that the time of obtaining the first information request is before the first order deadline in operation S1210 or when it is identified that the stock quantity of the first SKU is greater than or equal to the first quantity in operation S1240, the electronic apparatus 100 may determine the PDD of the first item as dawn on a following day.

In operation S1255, the electronic apparatus 100 may provide information on the PDD of the first item to the user terminal 110 according to an example embodiment. For example, the electronic apparatus 100 may transmit information on the cart page including information on the PDD of 5 of the first items to the user terminal 110.

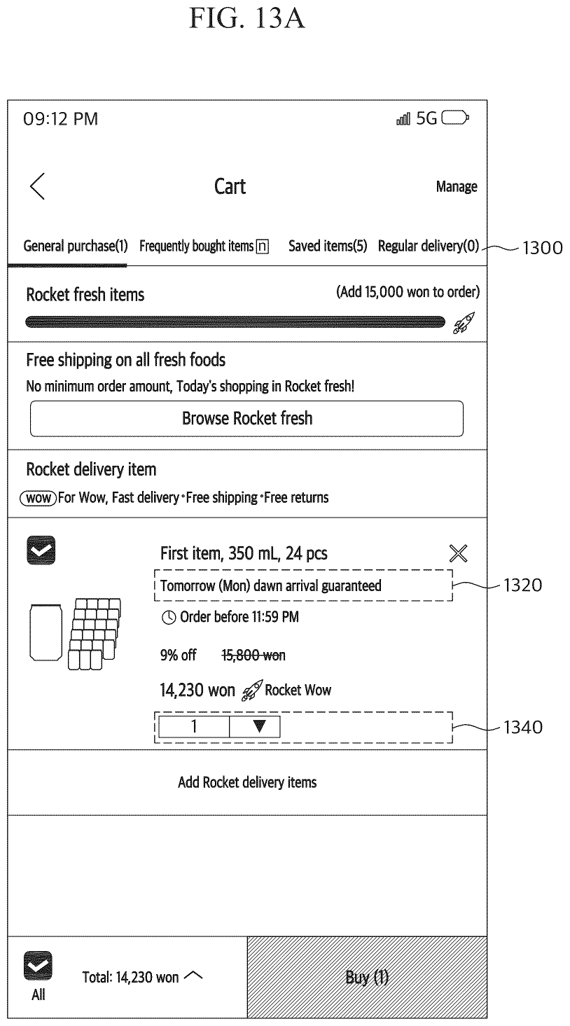

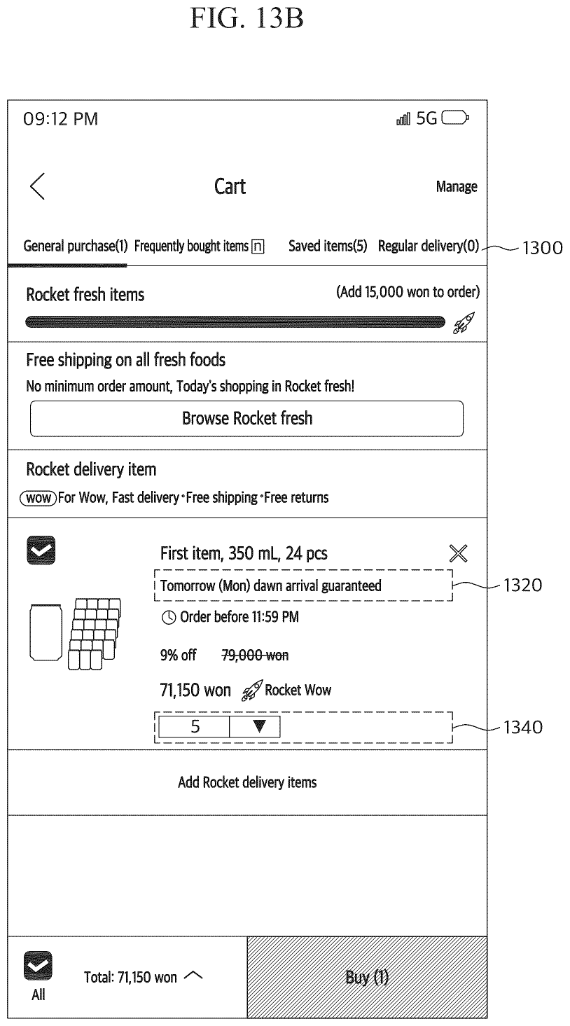

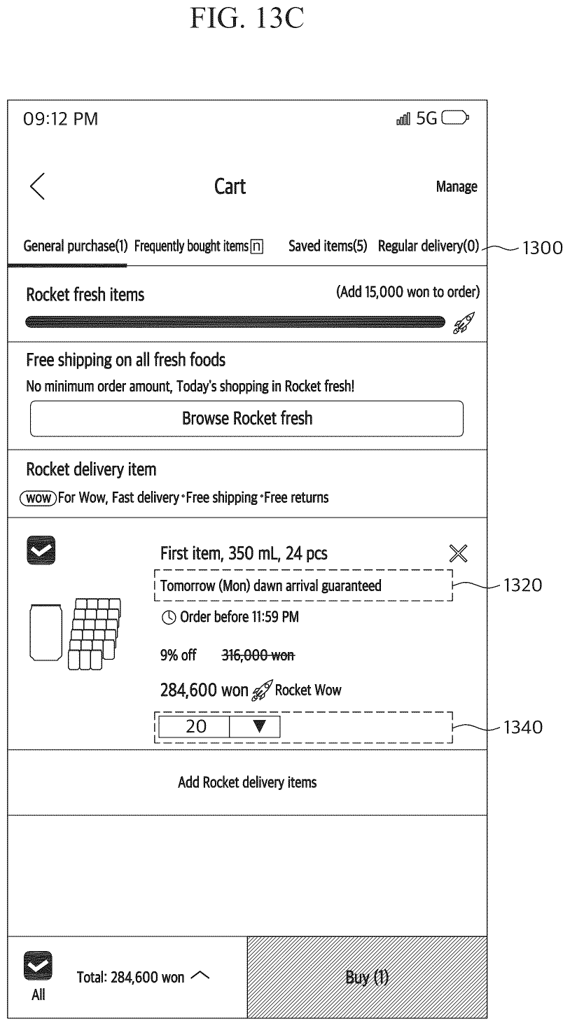

FIGS. 13A to 13C illustrate an example of a user interface provided by the electronic apparatus 100 according to an example embodiment.

According to an example embodiment, the electronic apparatus 100 may provide a page including information on a PDD of an item. For example, the user terminal 110 may obtain input from a user for adding 1 of a first item to a cart and transmit a request for a cart page to the electronic apparatus 100. The electronic apparatus 100 may identify that an SKU corresponding to the first item is one of a plurality of SKUs arranged in first-type zone groups and identify that a time (9:12 PM) of obtaining the request for the cart page is after a first order deadline (9 PM) and before a second order deadline (11:59 PM). Subsequently, as it is identified that a camp corresponding to a first address set as a delivery location by the user is a first-type camp and that a stock quantity of a first SKU arranged in the first-type zone groups is greater than or equal to 1, the electronic apparatus 100 may determine a PDD of the first item as a first time zone (dawn on a following day). Accordingly, referring to FIG. 13A, the electronic apparatus 100 may provide a cart page 1300 including an area 1320 representing information that the PDD of the first item is dawn on the following day.

According to an example embodiment, the electronic apparatus 100 may provide information on a changed PDD of an item based on an input of a user for changing a quantity.

For example, referring to FIG. 13A, as an input of the user for changing a quantity of the first item displayed on an area 1340 from 1 to 5 is obtained, the user terminal 110 may transmit a request for information on a PDD of 5 of the first items to the electronic apparatus 100. As it is identified that the stock quantity of the first SKU arranged in the first-type zone groups is greater than or equal to 5, the electronic apparatus 100 may determine the PDD of the first item as the first time zone (dawn on a following day). Accordingly, referring to FIG. 13B, the electronic apparatus 100 may provide the cart page 1300 including the area 1320 representing information that the PDD of the first item is dawn on the following day.

For another example, referring to FIG. 13A, as an input of the user for changing the quantity of the first item displayed on the area 1340 from 1 to 20 is obtained, the user terminal 110 may transmit a request for information on a PDD of 10 of the first items to the electronic apparatus 100. As it is identified that the stock quantity of the first SKU arranged in the first-type zone groups is less than 10, the electronic apparatus 100 may determine the PDD of the first item as a second time zone (a following day). Accordingly, referring to FIG. 13C, the electronic apparatus 100 may provide the cart page 1300 including the area 1320 representing information that the PDD of the first item is the following day.

As above, by identifying whether an SKU of a quantity changed in real-time is arranged in first-type zone groups as the electronic apparatus 100 obtains a user input for changing a quantity and providing information on a product delivery date changed based on a result of identification, a user purchase may be further induced and user experiences may be enhanced.

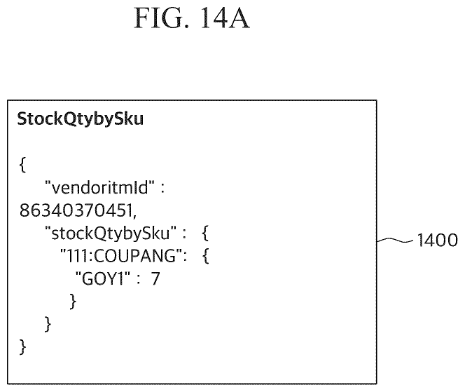

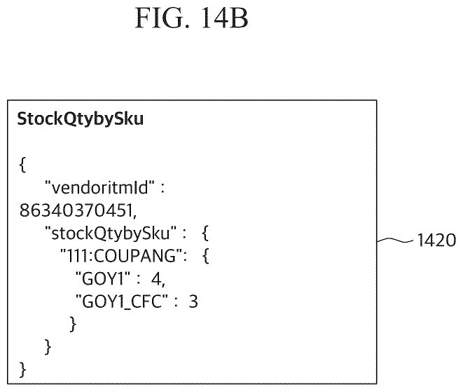

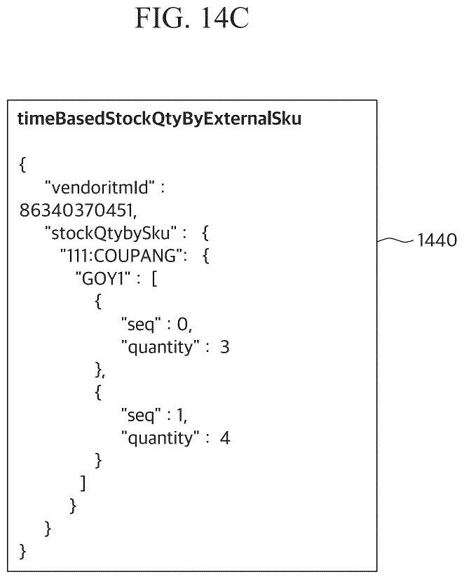

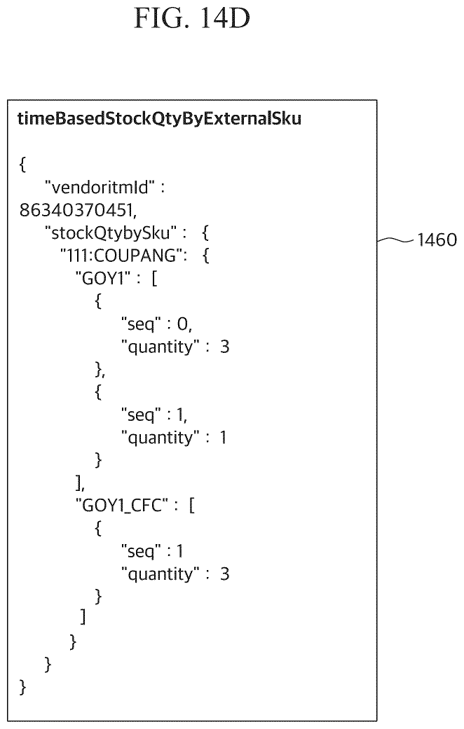

FIGS. 14A to 14D illustrate an example of stock information processed by the electronic apparatus 100 according to an example embodiment.

According to an example embodiment, the electronic apparatus 100 may perform a stock information processing process at a zone group level, which is previously performed at a fulfillment center level. More specifically, the electronic apparatus 100 may divide and process stock information of a fulfillment center into stock information of a first-type zone group within the fulfillment center and stock information of a zone group other than the first-type zone group within the fulfillment center.

For example, referring to FIG. 14A, when the electronic apparatus 100 processes stock information at a fulfillment center level, existing stock information 1400 may include information that stocks (GOY1) of a first-type SKU arranged in Goyang 1 fulfillment center are 7. In contrast, referring to FIG. 14B, when the electronic apparatus 100 processes stock information at a zone group level, stock information 1420 according to an example embodiment may include information that stocks (GOY1_CFC) of the first-type SKU arranged in the first-type zone group within Goyang 1 fulfillment center are 3 and information that stocks (GOY1) of an SKU arranged in a zone group other than the first-type zone group within Goyang 1 fulfillment center are 4.

According to an example embodiment, the electronic apparatus 100 may perform a processing process of information on arranged stock and information on stock to be arranged at a zone group level, which is previously performed at a fulfillment center level. More specifically, the electronic apparatus 100 may divide and process information on arranged stock and information on stock to be arranged of a fulfillment center into information on arranged stock and information on stock to be arranged in a first-type zone group within the fulfillment center and information on arranged stock and information on stock to be arranged in a zone group other than the first-type zone group within the fulfillment center.

For example, referring to FIG. 14C, when the electronic apparatus 100 processes stock information at a fulfillment center level, existing stock information 1440 may include information that stocks (GOY1, seq: 0) of a first-type SKU arranged in Goyang 1 fulfillment center are 3 and information that stocks (GOY1, seq: 1) of the first-type SKU to be arranged in Goyang 1 fulfillment center are 4. In contrast, referring to FIG. 14D, when the electronic apparatus 100 processes stock information at a zone group level, stock information 1460 according to an example embodiment may include information that stocks (GOY1_CFC, seq: 1) of the first-type SKU to be arranged in the first-type zone group within Goyang 1 fulfillment center are 3, information that stocks (GOY1, seq: 0) of an SKU arranged in a zone group other than the first-type zone group within Goyang 1 fulfillment center are 3, and information that stock (GOY1, seq: 1) of an SKU to be arranged in a zone group other than the first-type zone group within Goyang 1 fulfillment center is 1.

According to an example embodiment, the electronic apparatus 100 may determine a PDD of an item using stock information of an SKU to be arranged in a first-type zone group. More specifically, the electronic apparatus 100 may use a sum of a stock quantity of SKUs arranged in the first-type zone groups and a stock quantity of SKUs to be arranged in the first-type zone groups as a comparison value to a first quantity included in an information request received from the user terminal 110.

For example, the user terminal 110 may obtain input from a user for adding 2 of first items to a cart and transmit a request for a cart page to the electronic apparatus 100. The electronic apparatus 100 may identify that an SKU corresponding to the first item is one of a plurality of SKUs arranged in the first-type zone groups and identify that a time (9:12 PM) of obtaining the request for the cart page is after a first order deadline (9 PM) and before a second order deadline (11:59 PM). Subsequently, the electronic apparatus 100 may identify that a camp corresponding to a first address set as a delivery location by the user is a first-type camp and that a first stock quantity of a first SKU arranged in the first-type zone groups is less than 2. In this case, even though the first stock quantity of the first SKU arranged in the first-type zone groups is less than 2, the electronic apparatus 100 may identify a second stock quantity of the first SKU to be arranged in the first-type zone groups within a set time period instead of determining a PDD of the first item as a second time zone (a following day). As it is identified that the second stock quantity of the first SKU to be arranged in the first-type zone groups within the set time period is 3 and that a sum of the first stock quantity and the second stock quantity is greater than or equal to 2, the electronic apparatus 100 may determine the PDD of the first item as a first time zone (dawn on a following day).

As above, by determining a PDD of an item as the electronic apparatus 100 considers not only a quantity of stocks currently arranged in a fulfillment center but also a quantity of stocks to be arranged within a set time period, a user purchase may be further induced and user experiences may be enhanced.

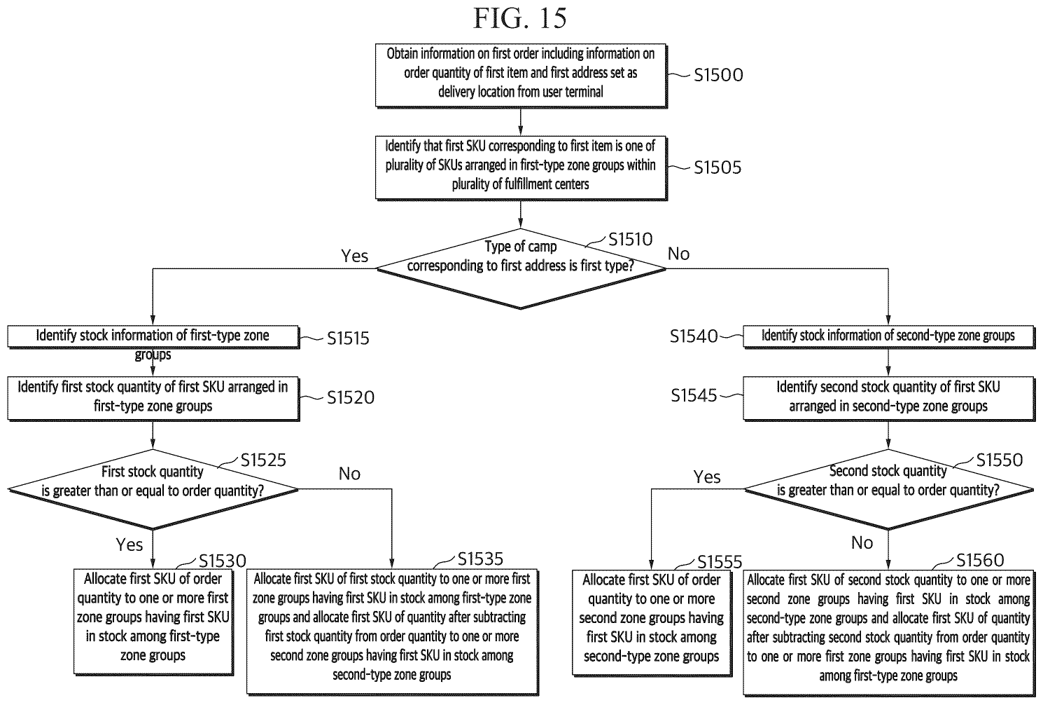

FIG. 15 is a diagram for illustrating a process of allocating an item ordered by a user by the electronic apparatus 100 according to an example embodiment. With regard to FIG. 4, duplicated content with the above description is briefly described or omitted.

In operation S1500, the electronic apparatus 100 may obtain information on a first order including information on an order quantity of a first item and a first address set as a delivery location from the user terminal 110 according to an example embodiment. For example, the user terminal 110 may transmit order information including information indicating that a user orders 5 of the first item and information on the first address set as the delivery location by the user to the electronic apparatus 100.

In operation S1505, the electronic apparatus 100 may identify that a first SKU corresponding to the first item is one of a plurality of SKUs arranged in first-type zone groups within a plurality of fulfillment centers according to an example embodiment. For example, as the information on the first order is received from the user terminal 110, the electronic apparatus 100 may identify the first SKU corresponding to the first item ordered by the user. Subsequently, the electronic apparatus 100 may identify that the first SKU is a first-type SKU arranged in the first-type zone groups.

In this case, the first-type zone group may refer to Fast Forward zone group, and SKUs corresponding to a set number of items of which purchasing frequencies by users are highest may be arranged in a zone included in the first-type zone groups.

In operation S1510, the electronic apparatus 100 may identify whether a type of a camp corresponding to the first address is a first type according to an example embodiment. For example, the electronic apparatus 100 may identify whether the camp corresponding to the first address set as the delivery location by the user is a camp of the first type. When the camp corresponding to the first address is the camp of the first type, the electronic apparatus 100 may perform operation S1515, and when the camp corresponding to the first address is not the camp of the first type, the electronic apparatus 100 may perform operation S1540.

In operation S1515, the electronic apparatus 100 may identify stock information of the first-type zone groups according to an example embodiment. For example, as it is identified that the type of the camp corresponding to the first address is the first type, the electronic apparatus 100 may identify the stock information of the first-type zone groups within the plurality of fulfillment centers, which is stored in the database 140.

In operation S1520, the electronic apparatus 100 may identify a first stock quantity of the first SKU arranged in the first-type zone groups according to an example embodiment. For example, the electronic apparatus 100 may identify how many stocks of the first SKU are arranged in the first-type zone groups based on the stock information of the first-type zone groups within the plurality of fulfillment centers.

In operation S1525, the electronic apparatus 100 may identify whether the first stock quantity is greater than or equal to the order quantity according to an example embodiment. For example, the electronic apparatus 100 may identify whether a stock quantity of the first SKU arranged in the first-type zone groups is greater than or equal to 5 ordered by the user. When the first stock quantity is greater than or equal to the order quantity, the electronic apparatus 100 may perform operation S1530, and when the first stock quantity is less than the order quantity, the electronic apparatus 100 may perform operation S1535.

In operation S1530, the electronic apparatus 100 may allocate the first SKU of the order quantity to one or more first zone groups having the first SKU in stock among the first-type zone groups according to an example embodiment. For example, as it is identified that the stock quantity of the first SKU arranged in the first-type zone groups is greater than or equal to 5, the electronic apparatus 100 may allocate the first SKU of 5 to the one or more first zone groups having the first SKU in stock among the first-type zone groups.

In operation S1535, the electronic apparatus 100 may allocate the first SKU of the first stock quantity to the one or more first zone groups having the first SKU in stock among the first-type zone groups and allocate the first SKU of a quantity after subtracting the first stock quantity from the order quantity to one or more second zone groups having the first SKU in stock among second-type zone groups according to an example embodiment. For example, as it is identified that the stock quantity of the first SKU arranged in the first-type zone groups is less than 5, the electronic apparatus 100 may allocate the first SKU of the first stock quantity to the one or more first zone groups having the first SKU in stock among the first-type zone groups and allocate the first SKU of a quantity after subtracting the first stock quantity from 5 to the one or more second zone groups having the first SKU in stock among the second-type zone groups.

In operation S1540, the electronic apparatus 100 may identify stock information of the second-type zone groups according to an example embodiment. For example, as it is identified in operation S1510 that the type of the camp corresponding to the first address is not the first type, the electronic apparatus 100 may identify the stock information of the second-type zone groups within the plurality of fulfillment centers, which is stored in the database 140.

In this case, the second-type zone group may refer to a zone group other than Fast Forward zone group and may include Manual zone group, Pre-pack zone group, AGV zone group, Multi-Manual zone group, or Unspecified zone group.

In operation S1545, the electronic apparatus 100 may identify a second stock quantity of the first SKU arranged in the second-type zone groups according to an example embodiment. For example, the electronic apparatus 100 may identify how many stocks of the first SKU are arranged in the second-type zone groups based on the stock information of the second-type zone groups within the plurality of fulfillment centers.

In operation S1550, the electronic apparatus 100 may identify whether the second stock quantity is greater than or equal to the order quantity according to an example embodiment. For example, the electronic apparatus 100 may identify whether a stock quantity of the first SKU arranged in the second-type zone groups is greater than or equal to 5 ordered by the user. When the second stock quantity is greater than or equal to the order quantity, the electronic apparatus 100 may perform operation S1555, and when the second stock quantity is less than the order quantity, the electronic apparatus 100 may perform operation S1560.

In operation S1555, the electronic apparatus 100 may allocate the first SKU of the order quantity to the one or more second zone groups having the first SKU in stock among the second-type zone groups according to an example embodiment. For example, as it is identified that the stock quantity of the first SKU arranged in the second-type zone groups is greater than or equal to 5, the electronic apparatus 100 may allocate the first SKU of 5 to the one or more second zone groups having the first SKU in stock among the second-type zone groups.

In operation S1560, the electronic apparatus 100 may allocate the first SKU of the second stock quantity to the one or more second zone groups having the first SKU in stock among the second-type zone groups and allocate the first SKU of a quantity after subtracting the second stock quantity from the order quantity to the one or more first zone groups having the first SKU in stock among the first-type zone groups according to an example embodiment. For example, as it is identified that the stock quantity of the first SKU arranged in the second-type zone groups is less than 5, the electronic apparatus 100 may allocate the first SKU of the second stock quantity to the one or more second zone groups having the first SKU in stock among the second-type zone groups and allocate the first SKU of a quantity after subtracting the second stock quantity from 5 to the one or more first zone groups having the first SKU in stock among the first-type zone groups.

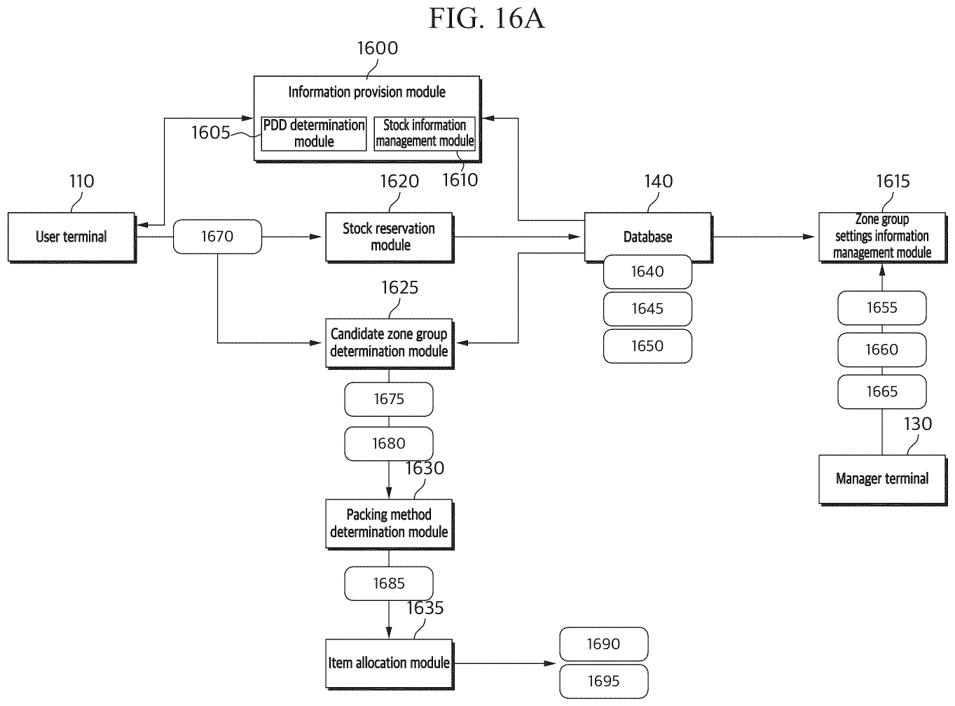

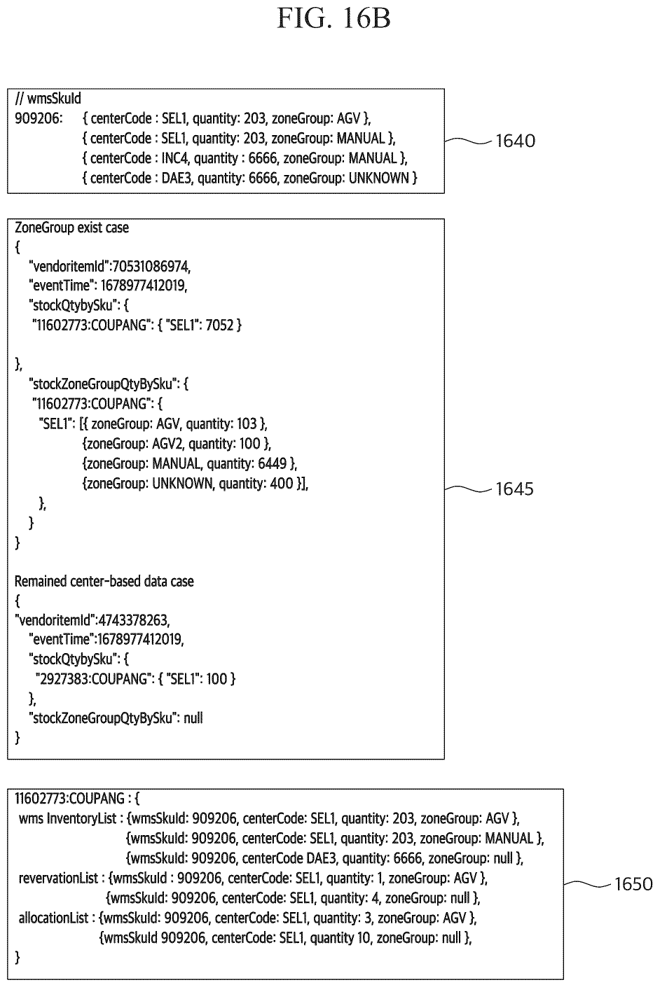

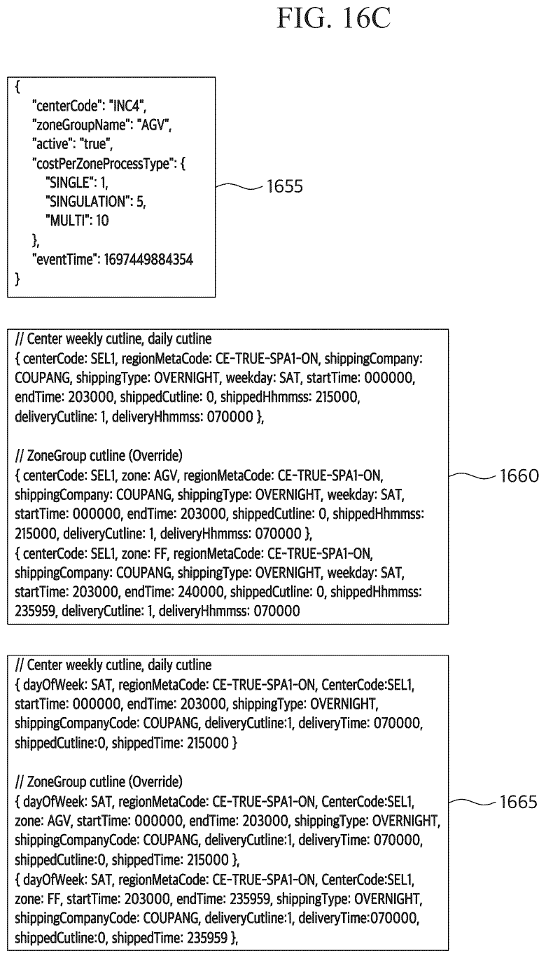

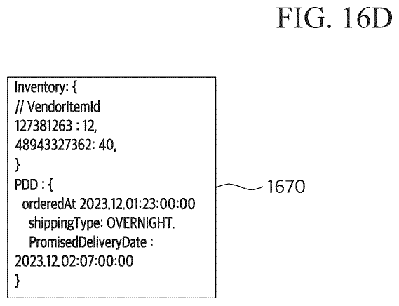

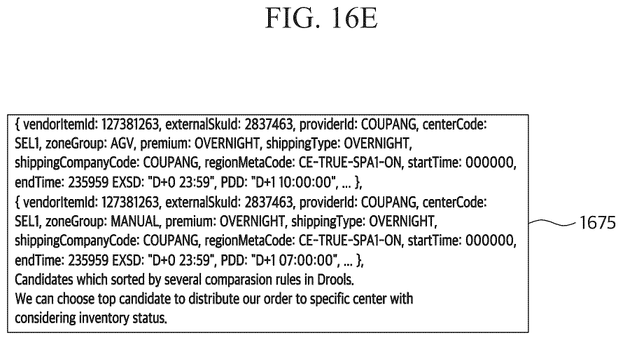

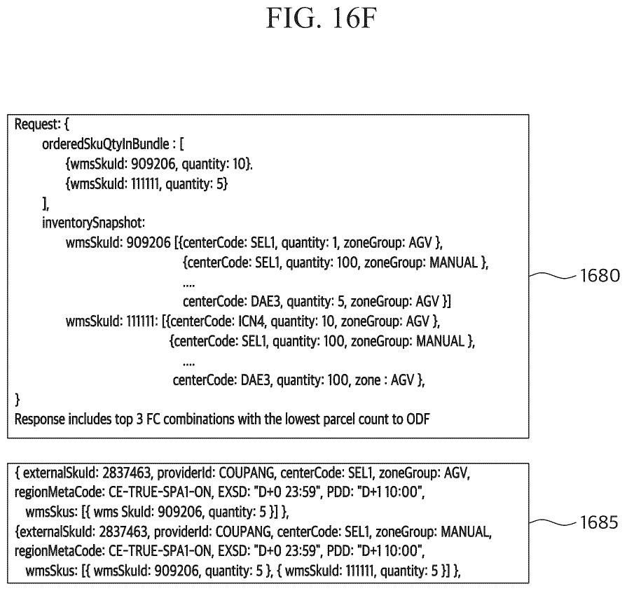

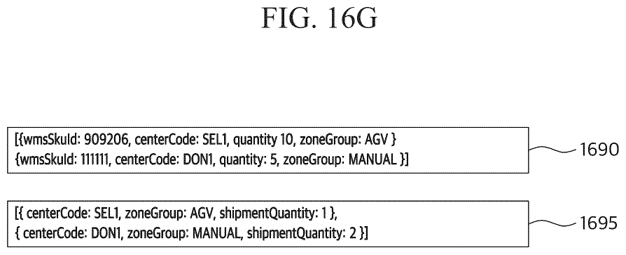

FIGS. 16A to 16G are diagrams for illustrating a process of determining an allocation method of one or more SKUs and a packing method of one or more SKUs by the electronic apparatus 100 according to an example embodiment. Each of an information provision module 1600, a zone group settings information management module 1615, a stock reservation module 1620, a candidate zone group determination module 1625, a packing method determination module 1630, and an item allocation module 1635 illustrated in FIG. 16A may be included in the electronic apparatus 100 or included in a server present outside the electronic apparatus 100.

According to an example embodiment, information on a quantity of an SKU may be stored and managed for each type of zone groups in the database 140. More specifically, information on a stock quantity of an SKU, information on a quantity of a reserved SKU, and information on a quantity of an allocated SKU may be divided based on types of zone groups within a fulfillment center to be stored and managed in the database 140.

For example, referring to FIG. 16B, information 1640 indicating that a stock quantity of a first SKU having an SKU identification value of 909206 arranged in AGV zone group within SEL1 fulfillment center is 203, that a stock quantity of the first SKU arranged in Manual zone group within SEL1 fulfillment center is 203, that a stock quantity of the first SKU arranged in Manual zone group within INC4 fulfillment center is 6666, and that a stock quantity of the first SKU arranged in Unknown (Unspecified) zone group within DAE3 fulfillment center is 6666 may be stored in the database 140.

For another example, referring to FIG. 16B, information 1645 indicating that a stock quantity of a second SKU having an SKU identification value of 11602773 arranged in AGV zone group within SEL1 fulfillment center is 103, that a stock quantity of the second SKU arranged in AGV2 zone group within SEL1 fulfillment center is 100, that a stock quantity of the second SKU arranged in Manual zone group within SEL1 fulfillment center is 6449, and that a stock quantity of the second SKU arranged in Unknown zone group within SEL1 fulfillment center is 400 may be stored in the database 140.

For another example, referring to FIG. 16B, information 1650 indicating that a stock quantity of the first SKU having the SKU identification value of 909206 arranged in AGV zone group within SEL1 fulfillment center is 203, that a stock quantity of the first SKU arranged in Manual zone group within SEL1 fulfillment center is 203, and that a stock quantity of the first SKU arranged in null (Unspecified) zone group within DAE3 fulfillment center is 6666 may be stored in the database 140. In addition, the information 1650 indicating that a quantity of the first SKU reserved among the first SKU arranged in AGV zone group within SEL1 fulfillment center is 1, that a quantity of the first SKU reserved among the first SKU arranged in null zone group within SEL1 fulfillment center is 4, a quantity of the first SKU allocated among the first SKU arranged in AGV zone group within SEL1 fulfillment center is 3, and a quantity of the first SKU allocated among the first SKU arranged in null zone group within SEL1 fulfillment center is 10 may be stored in the database 140.

According to an example embodiment, the zone group settings information management module 1615 may store a variety of settings information about a zone group in the database 140 based on information obtained from the manager terminal 130. More specifically, the zone group settings information management module 1615 may obtain and store in the database 140 cost information based on a packing manner set for each zone group and information on order deadlines of zone groups, which is inputted through a user interface provided by the manager terminal 130 by a manager.

For example, referring to FIG. 16C, the zone group settings information management module 1615 may obtain from the manager terminal 130 and store in the database 140 information 1655 for setting cost by a first packing manner (SINGLE) of packing SKUs individually to 1, cost by a second packing manner (SINGULATION) of packing an identical type of SKUs together to 5, and cost by a third packing manner (MULTI) of packing different types of SKUs together to 10 for AGV zone group within INC4 fulfillment center.

For another example, referring to FIG. 16C, the zone group settings information management module 1615 may obtain from the manager terminal 130 and store in the database 140 information 1660 for setting an order deadline (endTime) of SEL1 fulfillment center to 20:30:00, setting an order deadline of AGV zone group within SEL1 fulfillment center to 20:30:00, and setting an order deadline of FF zone group within SEL1 fulfillment center to 24:00:00.

For another example, referring to FIG. 16C, the zone group settings information management module 1615 may obtain from the manager terminal 130 and store in the database 140 information 1665 for setting the order deadline (endTime) of SEL1 fulfillment center to 20:30:00, setting the order deadline of AGV zone group within SEL1 fulfillment center to 20:30:00, and setting the order deadline of FF zone group within SEL1 fulfillment center to 23:59:59.

In this case, information on an order deadline of a fulfillment center may be provided to the information provision module 1600 or the candidate zone group determination module 1625, but when an order deadline of a specific zone group within the fulfillment center is set as in the information 1660 or 1665, information on the order deadline of the specific zone group within the fulfillment center may be overridden and provided to the information provision module 1600 or the candidate zone group determination module 1625.

According to an example embodiment, the information provision module 1600 may provide information on a PDD to a user. More specifically, as an information request for a first item is obtained from the user terminal 110, the information provision module 1600 may determine a PDD of the first item, based on information on a time of obtaining the information request, information on an address set as a delivery location by a user, information on order deadlines of a plurality of zone groups, and stock information of the plurality of zone groups, and provide information on the PDD of the first item to the user terminal 110.

For example, as the information provision module 1600 obtains the information request for the first item from the user terminal 110, a PDD determination module 1605 within the information provision module 1600 may identify one or more zone groups having a first SKU corresponding to the first item in stock among the plurality of zone groups based on the stock information of the plurality of zone groups. The PDD determination module 1605 may identify one or more PDDs corresponding to the one or more zone groups based on the information on the time of obtaining the information request, the information on the address set as the delivery location by the user, the information on the order deadlines of the plurality of zone groups and determine an earliest time among the one or more PDDs as the PDD of the first item. Subsequently, the information provision module 1600 may provide information on the determined PDD of the first item to the user terminal 110.

According to an example embodiment, the information provision module 1600 may provide information on a stock quantity of an item to a user. For example, as the information provision module 1600 obtains the information request for the first item from the user terminal 110, a stock information management module 1610 within the information provision module 1600 may identify a stock quantity of the first SKU corresponding to the first item, which is stored in the database 140. Subsequently, the information provision module 1600 may provide information on the stock quantity of the first SKU to the user terminal 110.

According to an example embodiment, the stock reservation module 1620 and the candidate zone group determination module 1625 may obtain information on a first order including information on one or more items from the user terminal 110. For example, referring to FIG. 16D, the stock reservation module 1620 and the candidate zone group determination module 1625 may obtain information 1670 on the first order including information that a user orders 12 of a first item having a vendor item identification value of 127381263 and 40 of a second item having a vendor item identification value of 48943327362 at 2023.12.01 23:00:00 and information that a PDD provided to the user is 23.12.02 07:00:00 from the user terminal 110.

According to an example embodiment, the stock reservation module 1620 may reserve a stock of one or more SKUs corresponding to one or more items ordered by a user. More specifically, the stock reservation module 1620 may change a state of the one or more SKUs by a stock quantity identical to an order quantity of the one or more items to a reserved state.

For example, the stock reservation module 1620 may arbitrarily select a fulfillment center and a zone group having in stock the one or more SKUs corresponding to the one or more items ordered by the user and change a state of the one or more SKUs arranged in the selected zone group to the reserved state.

For another example, when the item ordered by the user is a set-type item such as fresh items, the stock reservation module 1620 may identify fulfillment centers where the set-type item is arranged and change a state of the one or more SKUs arranged in a zone group within the corresponding fulfillment centers to the reserved state.

For another example, the stock reservation module 1620 may identify a fulfillment center and a zone group corresponding to a PDD of the one or more items provided to the user and change a state of the one or more SKUs arranged in the zone group within the identified fulfillment center to the reserved state.

In this case, as the state of the one or more SKUs is changed to the reserved state, the one or more SKUs may not be allocated to an order other than the first order for a set period.

According to an example embodiment, the candidate zone group determination module 1625 may determine candidate zone groups corresponding to each of one or more SKUs. More specifically, the candidate zone group determination module 1625 may identify a plurality of first zone groups having in stock a first SKU among the one or more SKUs and, based on information on PDDs corresponding to a plurality of zone groups, identify a plurality of second zone groups of which corresponding PDDs are earliest among the plurality of first zone groups. Subsequently, the candidate zone group determination module 1625 may identify a plurality of third zone groups of which a stock quantity of the first SKU is greater than or equal to an order quantity of a first item corresponding to the first SKU among the plurality of second zone groups based on stock information of the plurality of zone groups and may identify a plurality of fourth zone groups of which a priority of a corresponding fulfillment center is higher among the plurality of third zone groups based on information on a location of a fulfillment center including the plurality of zone groups. The candidate zone group determination module 1625 may determine zone groups of which a corresponding cost is lower among the plurality of fourth zone groups as at least one zone group corresponding to the first SKU based on information on costs by packing manners set for the plurality of zone groups.

For example, the candidate zone group determination module 1625 may identify a plurality of zone groups having in stock a first SKU corresponding to a vendor item identification value of 127381263 and having an SKU identification value of 2837463. Subsequently, referring to FIG. 16E, the candidate zone group determination module 1625 may determine AGV zone group and Manual zone group within SEL1 fulfillment center as candidate zone groups corresponding to the first SKU, based on information on PDDs corresponding to the plurality of zone groups, stock information of the plurality of zone groups, information on a location of a fulfillment center including the plurality of zone groups, and information on costs by packing manners set for the plurality of zone groups, and generate information 1675 about the candidate zone groups corresponding to the first SKU.

According to an example embodiment, the packing method determination module 1630 may determine a packing method for minimizing the number of parcels packing one or more SKUs. For example, referring to FIG. 16F, the packing method determination module 1630 may obtain a request 1680 for a packing method for minimizing the number of parcels packing 10 of a first SKU and 5 of a second SKU, including information on candidate zone groups corresponding to the first SKU having an SKU identification value of 909206 and candidate zone groups corresponding to the second SKU having 111111. Accordingly, the packing method determination module 1630 may determine a packing method to pick and pack 5 of the first SKU from AGV zone group within SEL1 fulfillment center and to pick and pack 5 of the first SKU and 5 of the second SKU from Manual zone group within SEL1 fulfillment center in order to minimize the number of packing parcels and may generate information 1685 on the packing method.

According to an example embodiment, the item allocation module 1635 may determine an allocation method of allocating one or more SKUs to one or more candidate zone groups. For example, referring to FIG. 16G, the item allocation module 1635 may generate information 1690 on an allocation method of allocating 10 of the first SKU having the SKU identification value of 909206 to AGV zone group within SEL1 fulfillment center and allocating 5 of the second SKU having 111111 to Manual zone group within DON1 fulfillment center. Accordingly, the item allocation module 1635 may generate information 1695 indicating that the number of boxes corresponding to AGV zone group within SEL1 fulfillment center is 1 and the number of boxes corresponding to Manual zone group within DON1 fulfillment center is 2.

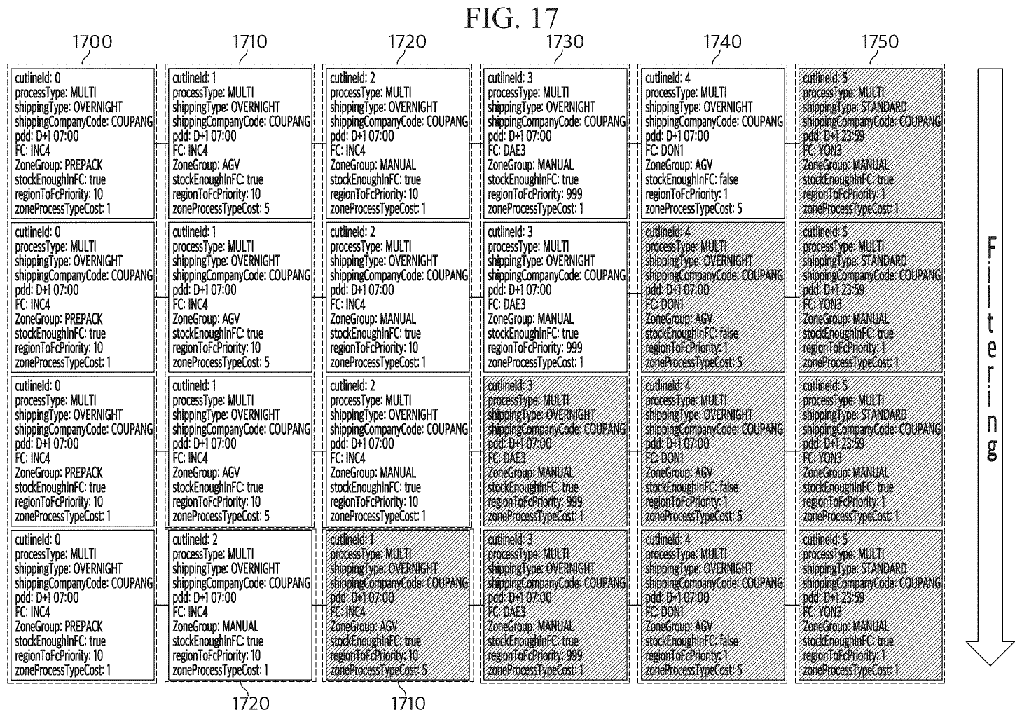

FIG. 17 is a diagram for illustrating a process of determining candidate zone groups corresponding to one or more SKUs by the electronic apparatus 100 according to an example embodiment.

According to an example embodiment, the electronic apparatus 100 may identify a plurality of first zone groups having a first SKU in stock. For example, referring to FIG. 17, the electronic apparatus 100 may identify a first zone group 1700, a second zone group 1710, a third zone group 1720, a fourth zone group 1730, a fifth zone group 1740, and a sixth zone group 1750, which have the first SKU in stock, based on stock information of a plurality of zone groups.

According to an example embodiment, the electronic apparatus 100 may identify a plurality of second zone groups of which corresponding PDDs are earliest among the plurality of first zone groups based on information on PDDs corresponding to the plurality of zone groups. For example, referring to FIG. 17, the electronic apparatus 100 may identify the first zone group 1700, the second zone group 1710, the third zone group 1720, the fourth zone group 1730, and the fifth zone group 1740 of which PDDs, D+1 07:00, are earliest among the first zone group 1700, the second zone group 1710, the third zone group 1720, the fourth zone group 1730, the fifth zone group 1740, and the sixth zone group 1750. Accordingly, the sixth zone group 1750 whose PDD, D+1 23:59, is later may be excluded.

In this case, D+1 07:00, which is the PDD corresponding to the first zone group 1700, the second zone group 1710, the third zone group 1720, the fourth zone group 1730, and the fifth zone group 1740 may denote a PDD provided to a user when the user orders a first item corresponding to the first SKU.

According to an example embodiment, the electronic apparatus 100 may identify a plurality of third zone groups of which a stock quantity of the first SKU is greater than or equal to an order quantity of the first item corresponding to the first SKU among the plurality of second zone groups based on the stock information of the plurality of zone groups. More specifically, the electronic apparatus 100 may identify the plurality of third zone groups having a first value as a value corresponding to a field about the stock quantity of the first SKU among the plurality of second zone groups.

For example, referring to FIG. 17, the electronic apparatus 100 may identify the first zone group 1700, the second zone group 1710, the third zone group 1720, and the fourth zone group 1730 which have a true value as a value corresponding to stockEnoughInFC among the first zone group 1700, the second zone group 1710, the third zone group 1720, the fourth zone group 1730, and the fifth zone group 1740. Accordingly, the fifth zone group 1740 where the first SKU of a quantity less than the quantity of the first item ordered by the user is arranged may be excluded.

In this case, having a true value as the value corresponding to stockEnoughInFC may indicate that a stock quantity of the first SKU arranged in a zone group is greater than or equal to the quantity of the first item ordered by the user, and having a false value as the value corresponding to stockEnoughInFC may indicate that a stock quantity of the first SKU arranged in a zone group is less than the quantity of the first item ordered by the user.

According to an example embodiment, the electronic apparatus 100 may identify a plurality of fourth zone groups of which a priority of a corresponding fulfillment center is higher among the plurality of third zone groups based on information on a location of a fulfillment center including the plurality of zone groups. More specifically, the electronic apparatus 100 may identify the plurality of fourth zone groups having a lowest value as a value corresponding to a field about a priority of a fulfillment center.

For example, referring to FIG. 17, the electronic apparatus 100 may identify the first zone group 1700, the second zone group 1710, and the third zone group 1720 which have the lowest value, 10, as a value corresponding to regionToFcPriority among the first zone group 1700, the second zone group 1710, the third zone group 1720, and the fourth zone group 1730. Accordingly, the fourth zone group 1730 of which a priority of a corresponding fulfillment center is lower may be excluded.

In this case, a higher priority may be assigned to a fulfillment center located closer to an address set as a delivery location by the user than a fulfillment center located farther from the address set as the delivery location by the user.

According to an example embodiment, the electronic apparatus 100 may determine zone groups of which a corresponding cost is lower among the plurality of fourth zone groups as a candidate zone group corresponding to the first SKU based on information on costs by packing manners set for the plurality of zone groups. For example, referring to FIG. 17, the electronic apparatus 100 may identify that cost by a third packing manner (MULTI) of packing different types of SKUs together set for the first zone group 1700 is 1, cost by the third packing manner (MULTI) of packing different types of SKUs together set for the second zone group 1710 is 5, and cost by the third packing manner (MULTI) of packing different types of SKUs together set for the third zone group 1720 is 1. Subsequently, the electronic apparatus 100 may determine the first zone group 1700 and the third zone group 1720 of which the cost by the packing manner is lower as the candidate zone group corresponding to the first SKU. Accordingly, the second fulfillment center 1710 of which the cost by the packing manner is higher may be excluded.

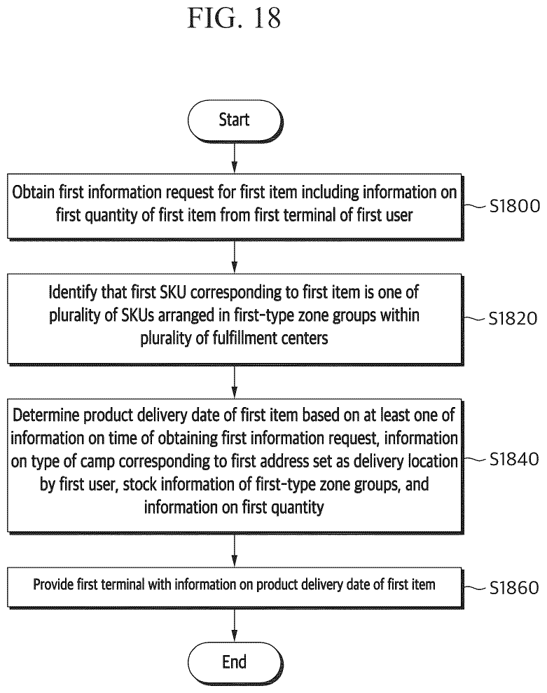

FIG. 18 shows a flowchart of a method of providing information by an electronic apparatus according to an example embodiment. The above description may be applied to duplicated content.

In operation S1800, the electronic apparatus may obtain a first information request for a first item including information on a first quantity of the first item from a first terminal of a first user.

According to an example embodiment, the first information request may include at least one of a request for a search result page about a list of a plurality of items including the first item, a request for a product detail page about the first item, a request for a cart page about one or more items including the first item, and a request for a payment page about the one or more items.

In operation S1820, the electronic apparatus may identify that a first stock keeping unit (SKU) corresponding to the first item is one of a plurality of SKUs arranged in first-type zone groups within a plurality of fulfillment centers.

In operation S1840, the electronic apparatus may determine a product delivery date (PDD) of the first item based on at least one of information on a time of obtaining the first information request, information on a type of a camp corresponding to a first address set as a delivery location by the first user, stock information of the first-type zone groups, and the information on the first quantity.

According to an example embodiment, when determining the PDD of the first item, the electronic apparatus may, when the time of obtaining the first information request is before a first order deadline, determine the PDD of the first item as a first time zone.

According to an example embodiment, when determining the PDD of the first item, the electronic apparatus may, when the time of obtaining the first information request is after a first order deadline and before a second order deadline, identify the first address set as the delivery location by the first user, when the camp corresponding to the first address is a first-type camp, identify a first stock quantity of the first SKU arranged in the first-type zone groups based on the stock information of the first-type zone groups, and when the first stock quantity is greater than or equal to the first quantity, determine the PDD of the first item as a first time zone.

According to an example embodiment, when determining the PDD of the first item, the electronic apparatus may, when the time of obtaining the first information request is after a first order deadline and before a second order deadline, identify the first address set as the delivery location by the first user, when the camp corresponding to the first address is a first-type camp, identify a first stock quantity of the first SKU arranged in the first-type zone groups based on the stock information of the first-type zone groups, and when the first stock quantity is less than the first quantity, determine the PDD of the first item as a second time zone.

According to an example embodiment, when determining the PDD of the first item, the electronic apparatus may, when the time of obtaining the first information request is after a first order deadline and before a second order deadline, identify the first address set as the delivery location by the first user, when the camp corresponding to the first address is a first-type camp, identify a first stock quantity of the first SKU arranged in the first-type zone groups based on the stock information of the first-type zone groups, when the first stock quantity is less than the first quantity, identify a second stock quantity of the first SKU to be arranged in the first-type zone groups within a set time period, and when a sum of the first stock quantity and the second stock quantity is greater than or equal to the first quantity, determine the PDD of the first item as a first time zone.

According to an example embodiment, when determining the PDD of the first item, the electronic apparatus may, when the time of obtaining the first information request is after a first order deadline and before a second order deadline, identify the first address set as the delivery location by the first user, and when the camp corresponding to the first address is a second-type camp, determine the PDD of the first item as a second time zone.

In operation S1860, the electronic apparatus may provide the first terminal with information on the PDD of the first item.

According to an example embodiment, the electronic apparatus may obtain information on a first order including information on a first order quantity and a first order time of the first item from the first terminal, and based on the information on the type of the camp corresponding to the first address and the stock information of the first-type zone groups, allocate the first SKU of the first order quantity.

According to an example embodiment, when allocating the first SKU of the first order quantity, the electronic apparatus may, when the camp corresponding to the first address is a first-type camp, identify a third stock quantity of the first SKU arranged in the first-type zone groups based on the stock information of the first-type zone groups, and when the third stock quantity is greater than or equal to the first order quantity, allocate the first SKU of the first order quantity to one or more first zone groups having the first SKU in stock among the first-type zone groups.

According to an example embodiment, when allocating the first SKU of the first order quantity, the electronic apparatus may, when the camp corresponding to the first address is a first-type camp, identify a third stock quantity of the first SKU arranged in the first-type zone groups based on the stock information of the first-type zone groups, and when the third stock quantity is less than the first order quantity, allocate the first SKU of the third stock quantity to one or more first zone groups having the first SKU in stock among the first-type zone groups and allocate the first SKU of a quantity after subtracting the third stock quantity from the first order quantity to one or more second zone groups having the first SKU in stock among second-type zone groups.

According to an example embodiment, when allocating the first SKU of the first order quantity, the electronic apparatus may, when the camp corresponding to the first address is a second-type camp, identify stock information of second-type zone groups, identify a fourth stock quantity of the first SKU arranged in the second-type zone groups based on the stock information of the second-type zone groups, and when the fourth stock quantity is greater than or equal to the first order quantity, allocate the first SKU of the first order quantity to one or more second zone groups having the first SKU in stock among the second-type zone groups.

According to an example embodiment, when allocating the first SKU of the first order quantity, the electronic apparatus may, when the camp corresponding to the first address is a second-type camp, identify stock information of second-type zone groups, identify a fourth stock quantity of the first SKU arranged in the second-type zone groups based on the stock information of the second-type zone groups, and when the fourth stock quantity is less than the first order quantity, allocate the first SKU of the fourth stock quantity to one or more second zone groups having the first SKU in stock among the second-type zone groups and allocate the first SKU of a quantity after subtracting the fourth stock quantity from the first order quantity to one or more first zone groups having the first SKU in stock among the first-type zone groups.

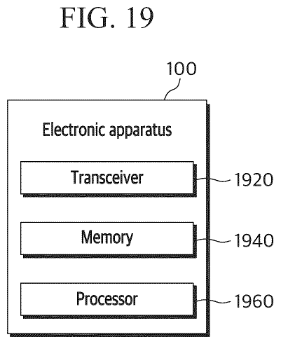

FIG. 19 shows a block diagram of the electronic apparatus 100 according to an example embodiment.

According to an example embodiment, the electronic apparatus 100 may include a transceiver 1920, a memory 1940, and a processor 1960. In the electronic apparatus 100 illustrated in FIG. 19, elements related to the example embodiments are illustrated. Therefore, it may be understood by those of ordinary skill in the art to which the example embodiments pertain that other general-purpose elements in addition to the elements illustrated in FIG. 19 may be further included. In example embodiments, the transceiver 1920 may be included in a communication device. Further, in example embodiments, the processor 1960 may be included in a controller.

The transceiver 1920 may be a device for performing wired and wireless communications and may communicate with an external electronic apparatus. The external electronic apparatus may be a terminal or a server. In addition, a communication technology used by the transceiver 1920 may include a global system for mobile communication (GSM), code division multi-access (CDMA), long term evolution (LTE), 5G, wireless local area network (WLAN), wireless-fidelity (Wi-Fi), Bluetooth, radio frequency identification (RFID), infrared data association (IrDA), ZigBee, near field communication (NFC), or the like.

The processor 1960 may control the overall operation of the electronic apparatus 100 and process data and signals. The processor 1960 may consist of at least one hardware unit. In addition, the processor 1960 may operate by one or more software modules generated by executing program codes stored in the memory 1940. The processor 1960 may include memory, and the processor 1960 may control the overall operation of the electronic apparatus 100 and process data and signals by executing the program codes stored in the memory.

The processor 1960 may be configured to obtain a first information request for a first item including information on a first quantity of the first item from a first terminal of a first user, identify that a first stock keeping unit (SKU) corresponding to the first item is one of a plurality of SKUs arranged in first-type zone groups within a plurality of fulfillment centers, determine a product delivery date (PDD) of the first item based on at least one of information on a time of obtaining the first information request, information on a type of a camp corresponding to a first address set as a delivery location by the first user, stock information of the first-type zone groups, and the information on the first quantity, and provide the first terminal with information on the PDD of the first item.

The electronic apparatus according to the above-described example embodiments may include a processor, a memory for storing and executing program data, a permanent storage such as a disk drive, a communication port that communicates with an external device, and a user interface device such as a touch panel, a key, and a button. Methods implemented as software modules or algorithms may be stored in a computer-readable recording medium as computer-readable codes or program instructions executable on the processor. Here, the computer-readable recording medium includes a magnetic storage medium (for example, read-only memory (ROM), random-access memory (RAM), floppy disks, and hard disks) and an optically readable medium (for example, CD-ROM and digital versatile discs (DVDs)). The computer-readable recording medium may be distributed among network-connected computer systems, so that the computer-readable codes may be stored and executed in a distributed manner. The medium may be readable by a computer, stored in a memory, and executed on a processor.

The example embodiments may be represented by functional block elements and various processing steps. The functional blocks may be implemented in any number of hardware and/or software configurations that perform specific functions. For example, an example embodiment may adopt integrated circuit configurations, such as memory, processing, logic, and/or look-up table, which may execute various functions by the control of one or more microprocessors or other control devices. Similarly to that elements may be implemented as software programming or software elements, the example embodiments may be implemented in a programming or scripting language such as C, C++, Java, assembler, etc., including various algorithms implemented as a combination of data structures, processes, routines, or other programming constructs. Functional aspects may be implemented in an algorithm running on one or more processors. Further, the example embodiments may adopt the existing art for electronic environment setting, signal processing, and/or data processing. Terms such as “mechanism,” “element,” “means,” and “configuration” may be used broadly and are not limited to mechanical and physical configurations. The terms may include the meaning of a series of routines of software in association with a processor or the like.

The above-described example embodiments may be implemented with artificial intelligence (AI) through a processor and a memory of the electronic apparatus. The processor may be composed of one or a plurality of processors. In this case, the one or plurality of processors may be a general-purpose processor such as a central processing unit (CPU), an application processor (AP), and a digital signal processor (DSP), a dedicated graphics processor such as a graphics processing unit (GPU) and a vision processing unit (VPU), or a dedicated AI processor such as a neural processing unit (NPU). The one or plurality of processors may control input data to be processed according to predefined operation rules or an AI model stored in the memory. Alternatively, when the one or plurality of processors are a dedicated AI processor, the dedicated AI processor may be designed with a hardware structure specialized for processing a particular AI model.

The predefined operation rules or the AI model may be created through training. Here, being created through training may refer to the predefined operation rules or the AI model set to perform a desired characteristic (or purpose) being created by training a basic AI model based on a large number of training data via a learning algorithm. Such training may be performed by the electronic apparatus itself in which AI is performed according to the present disclosure or may be performed through a separate server and/or system. Examples of the learning algorithm may include, but are not limited to, supervised learning, unsupervised learning, semi-supervised learning, or reinforcement learning.

The AI model may consist of a plurality of neural network layers. Each of the plurality of neural network layers may have a plurality of weight values and may perform neural network computations through computations between a result of computations in a previous layer and the plurality of weight values. The plurality of weight values of the plurality of neural network layers may be optimized by a result of training the AI model. For example, the plurality of weight values may be updated to reduce or minimize a loss or cost value obtained in the AI model during a training process. An artificial neural network may include a deep neural network (DNN), and may be, for example, a convolutional neural network (CNN), a recurrent neural network (RNN), a restricted Boltzmann machine (RBM), a deep belief network (DBN), a bidirectional recurrent DNN (BRDNN), or deep Q-networks but is not limited thereto.

The above-described example embodiments are merely examples, and other example embodiments may be implemented within the scope of the claims to be described later.

What is claimed is:

1. A method of providing information by an electronic apparatus, the method comprising:
obtaining a first information request for a first item including information on a first quantity of the first item from a first terminal of a first user;
identifying that a first stock keeping unit (SKU) corresponding to the first item is one of a plurality of SKUs arranged in first-type zone groups within a plurality of fulfillment centers;
determining a product delivery date (PDD) of the first item based on at least one of information on a time of obtaining the first information request, information on a type of a camp corresponding to a first address set as a delivery location by the first user, stock information of the first-type zone groups, and the information on the first quantity; and
providing the first terminal with information on the PDD of the first item.

2. The method of claim 1, wherein the determining of the PDD of the first item comprises, when the time of obtaining the first information request is before a first order deadline, determining the PDD of the first item as a first time zone.

3. The method of claim 1, wherein the determining of the PDD of the first item comprises:
when the time of obtaining the first information request is after a first order deadline and before a second order deadline, identifying the first address set as the delivery location by the first user;
when the camp corresponding to the first address is a first-type camp, identifying a first stock quantity of the first SKU arranged in the first-type zone groups based on the stock information of the first-type zone groups; and
when the first stock quantity is greater than or equal to the first quantity, determining the PDD of the first item as a first time zone.

4. The method of claim 1, wherein the determining of the PDD of the first item comprises:
when the time of obtaining the first information request is after a first order deadline and before a second order deadline, identifying the first address set as the delivery location by the first user;
when the camp corresponding to the first address is a first-type camp, identifying a first stock quantity of the first SKU arranged in the first-type zone groups based on the stock information of the first-type zone groups; and
when the first stock quantity is less than the first quantity, determining the PDD of the first item as a second time zone.

5. The method of claim 1, wherein the determining of the PDD of the first item comprises:
when the time of obtaining the first information request is after a first order deadline and before a second order deadline, identifying the first address set as the delivery location by the first user;
when the camp corresponding to the first address is a first-type camp, identifying a first stock quantity of the first SKU arranged in the first-type zone groups based on the stock information of the first-type zone groups;
when the first stock quantity is less than the first quantity, identifying a second stock quantity of the first SKU to be arranged in the first-type zone groups within a set time period; and
when a sum of the first stock quantity and the second stock quantity is greater than or equal to the first quantity, determining the PDD of the first item as a first time zone.

6. The method of claim 1, wherein the determining of the PDD of the first item comprises:
when the time of obtaining the first information request is after a first order deadline and before a second order deadline, identifying the first address set as the delivery location by the first user; and
when the camp corresponding to the first address is a second-type camp, determining the PDD of the first item as a second time zone.

7. The method of claim 1, further comprising:
obtaining information on a first order including information on a first order quantity and a first order time of the first item from the first terminal; and
based on the information on the type of the camp corresponding to the first address and the stock information of the first-type zone groups, allocating the first SKU of the first order quantity.

8. The method of claim 7, wherein the allocating of the first SKU of the first order quantity comprises:
when the camp corresponding to the first address is a first-type camp, identifying a third stock quantity of the first SKU arranged in the first-type zone groups based on the stock information of the first-type zone groups; and
when the third stock quantity is greater than or equal to the first order quantity, allocating the first SKU of the first order quantity to one or more first zone groups having the first SKU in stock among the first-type zone groups.

9. The method of claim 7, wherein the allocating of the first SKU of the first order quantity comprises:
when the camp corresponding to the first address is a first-type camp, identifying a third stock quantity of the first SKU arranged in the first-type zone groups based on the stock information of the first-type zone groups; and
when the third stock quantity is less than the first order quantity, allocating the first SKU of the third stock quantity to one or more first zone groups having the first SKU in stock among the first-type zone groups and allocating the first SKU of a quantity after subtracting the third stock quantity from the first order quantity to one or more second zone groups having the first SKU in stock among second-type zone groups.

10. The method of claim 7, wherein the allocating of the first SKU of the first order quantity comprises:
when the camp corresponding to the first address is a second-type camp, identifying stock information of second-type zone groups;
identifying a fourth stock quantity of the first SKU arranged in the second-type zone groups based on the stock information of the second-type zone groups; and
when the fourth stock quantity is greater than or equal to the first order quantity, allocating the first SKU of the first order quantity to one or more second zone groups having the first SKU in stock among the second-type zone groups.

11. The method of claim 7, wherein the allocating of the first SKU of the first order quantity comprises:
when the camp corresponding to the first address is a second-type camp, identifying stock information of second-type zone groups;
identifying a fourth stock quantity of the first SKU arranged in the second-type zone groups based on the stock information of the second-type zone groups; and
when the fourth stock quantity is less than the first order quantity, allocating the first SKU of the fourth stock quantity to one or more second zone groups having the first SKU in stock among the second-type zone groups and allocating the first SKU of a quantity after subtracting the fourth stock quantity from the first order quantity to one or more first zone groups having the first SKU in stock among the first-type zone groups.

12. The method of claim 1, wherein the first information request includes at least one of:
a request for a search result page about a list of a plurality of items including the first item;
a request for a product detail page about the first item;
a request for a cart page about one or more items including the first item; and
a request for a payment page about the one or more items.

13. A non-transitory computer-readable recording medium having a program for executing the method of claim 1 on a computer.

14. An electronic apparatus comprising:
a transceiver;
a memory; and
a processor,
wherein the processor is configured to obtain a first information request for a first item including information on a first quantity of the first item from a first terminal of a first user, identify that a first stock keeping unit (SKU) corresponding to the first item is one of a plurality of SKUs arranged in first-type zone groups within a plurality of fulfillment centers, determine a product delivery date (PDD) of the first item based on at least one of information on a time of obtaining the first information request, information on a type of a camp corresponding to a first address set as a delivery location by the first user, stock information of the first-type zone groups, and the information on the first quantity, and provide the first terminal with information on the PDD of the first item.
